(19) United States
(12) Patent Application Publication
(10) Pub. No.: US 2008/0044596 A1
(43) Pub. Date: Feb. 21, 2008

(54) Polymer film, production method thereof, and polarizing plate and liquid crystal display device using the polymer film

(75) Inventors: Nobutaka Fukagawa, Minami-Ashigara-shi (JP); Mitsuo Yoshikane, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/892,146

(22) Filed: Aug. 20, 2007

(30) Foreign Application Priority Data
Aug. 21, 2006 (JP) 2006-223975

(51) Int. Cl. C09K 19/02; B29D 11/00; G02B 5/30; G02F 1/1335

(52) U.S. Cl. 428/1.2; 264/1.34; 349/96; 359/485; 428/212

(57) ABSTRACT

A polymer film satisfies the following formulae (1) and (2):

0.025≦Pₜ≦0.100 Formula (1)

0.90≦Pₒ/Pₜ≦0.99 Formula (2)

wherein Pₒ represents an in-plane orientation degree of polymer molecular chain in the film surface, and Pₜ represents an average in-plane orientation degree of polymer molecular chain in the entire film thickness.

### BACKGROUND OF THE INVENTION

1. Field of the Invention

The present invention relates to a polymer film, a production method thereof, and a polarizing plate and a liquid crystal display device each using the polymer film.

2. Description of the Related Art

With recent increase in the size of a liquid crystal display, use of the liquid crystal display is started in new usage such as television, and more enhancement of the pictorial quality is required. Above all, the dependency of contrast and color tint on the viewing angle is a problem peculiar to the liquid crystal display device, and the requirement to improve these performances is particularly high.

For meeting such a requirement, in addition to a conventional TN mode, a new liquid crystal mode such as IPS, VA and OCB has been proposed. However, in any of these liquid crystal modes, it is difficult to obtain the contrast and viewing angle dependency in a satisfactory level by a liquid crystal cell alone, and the birefringence of the liquid crystal cell is generally compensated for by some phase difference film.

A cellulose acylate film has been heretofore used as a polarizing plate protective film but in recent years, a method of aggressively imparting a phase difference to the cellulose acylate film and using the film as an optically-compensatory film has been proposed. For example, JP-A-2003-170492 (the term “JP-A” as used herein means an “unexamined published Japanese patent application”) discloses a method of using a tenter-stretched cellulose acylate film as a phase difference film of a VA-type liquid crystal mode.

However, in this method, it is difficult to satisfy both the enhancement of retardation developability and reduction of haze. More specifically, a cellulose acylate used as a polarizing plate protective film generally has a small intrinsic birefringence and in order to impart retardation required of the optically-compensatory film, it is necessary to perform stretching at a high stretch ratio or increase the film thickness, but these techniques both incurs increased haze of the film. If a film having a large haze is used as the optically-compensatory film, there arises a problem that the contrast of the liquid crystal display device decreases. In this regard, an improvement is strongly demanded.

### SUMMARY OF THE INVENTION

The present invention provides a polymer film assured of large retardation and low haze and useful as a protective film or an optically-compensatory film, and a production method thereof. Another object of the present invention is to provide a polarizing plate using the polymer film and ensuring that a high-contrast high-quality image can be displayed, and a liquid crystal display device using the polarizing plate.

As a result of intensive studies, the present inventors have found that uniform orientation of the cellulose acylate molecular chain in a polymer film, specifically, a cellulose acylate film, is effective for both the enhancement of retardation developability and the reduction of haze. The present invention has been accomplished based on this finding.

That is, the above-described objects of the present invention have been attained by the following constructions 1) to 12).

1) A polymer film satisfying the following formulae (1) and (2):

0.025≦Pₜ≦0.100 Formula (1)

0.90≦Pₒ/Pₜ≦0.99 Formula (2)

wherein Pₒ represents an in-plane orientation degree of polymer molecular chain in the film surface, and

Pₜ represents an average in-plane orientation degree of polymer molecular chain in the entire film thickness.

2) A polymer film as described in 1), satisfying the following formulae (3) and (4):

0.070≦Qₘ≦0.150 Formula (3)

0.01%≦Q_{f}≦5% Formula (4)

wherein Qₘ represents an average value of Q in a thickness direction, in which Q represents an out-plane orientation degree of polymer molecular chain, and

Q_{f} represents a fluctuation coefficient of out-plane orientation degree, represented by the following formula (A):

Q_{f}=100×(maximum value of Q−minimum value of Q)/Qₘ. Formula (A)

3) The polymer film as described in 1), satisfying the following formulae (5) to (7):

20 nm≦Re(590)≦200 nm Formula (5)

70 nm≦Rth(590)≦400 nm Formula (6)

1≦Rth(590)/Re(590)≦10 Formula (7)

wherein Re(590) represents an in-plane retardation at a wavelength of 590 nm, and

Rth(590) represents a retardation in a thickness direction at a wavelength of 590 nm.

4) The polymer film as described in 1), having a haze of from 0.01 to 0.8%.

5) The polymer film as described in 1), having a thickness of from 20 to 100 μm.

6) A production method of a polymer film, comprising:

a step of stretching a polymer film which contains a solvent of from 0.01 to 4 mass % at a stretching temperature of from glass transition temperature of the film to glass transition temperature of the polymer film+30° C. and at a stretching rate of from 80%/min to 190%/min.

7) The production method as described in 6),

wherein the polymer film satisfies the following conditions (i) and at least one of (ii) and (iii):
(i) the polymer film contains at least two kinds of additives,
(ii) in a concentration distribution in a thickness direction of each of the at least two kinds of additives, a position in the thickness direction exhibiting the minimum concentration differs from each other,
(iii) in the concentration distribution in a thickness direction of each of the at least two kinds of additives, a position in the thickness direction exhibiting the maximum concentration differs from each other.

8) The production method according to claim 7),

wherein each of the at least two kinds of additives is selected from the group consisting of a plasticizer, a retardation developer, a retardation decreasing agent and an ultraviolet absorbent.

9) The polymer film as described in 1), which is produced by the production method comprising:

a step of stretching a polymer film which contains a solvent of from 0.01 to 4 mass % at a stretching temperature of from glass transition temperature of the film to glass transition temperature of the polymer film+30° C. and at a stretching rate of from 80%/min to 190%/min.

10) The polymer film as described in 9), comprising a cellulose acylate.

11) A polarizing plate comprising:

a polarizer; and

a pair of protective films between which the polarizer is sandwiched,

wherein at least one of the protective films is the polymer film as described in 1).

12) A liquid crystal display device comprising:

a liquid cell; and

two polarizing plates disposed on both sides of the liquid cell,

wherein at least one of the polarizing plates is the polarizing plate as described in 11).

### BRIEF DESCRIPTION OF THE DRAWING

FIGS. 1A and 1B are cross-sectional views for explaining one example of the construction where the polarizing plate of the present invention is combined with the functional optical film;

FIG. 2 is a view for explaining one example of a liquid crystal display device using the polarizing plate of the present invention; and

FIG. 3 is a cross-sectional view for explaining one example of a VA-mode liquid crystal display device using the polarizing plate of the present invention,

wherein 1, 1a and 1b denote Protective film, 2 denotes Polarizer, 3 denotes Functional optical film, 4 denotes Adhesive layer, 5 denotes Polarizing plate, 6 denotes Upper polarizing plate, 7 denotes Absorption axis of upper polarizing plate, 8 denotes Upper optically anisotropic layer, 9 denotes Orientation control direction of upper optically anisotropic layer, 10 denotes Upper electrode substrate of liquid crystal cell, 11 denotes Orientation control direction of upper substrate, 12 denotes Liquid crystal molecule, 13 denotes Lower electrode substrate of liquid crystal cell, 14 denotes Orientation control direction of lower substrate, 15 denotes Lower optically anisotropic layer, 16 denotes Orientation control direction of lower optically anisotropic layer, 17 denotes Lower polarizing plate, 18 denotes Absorption axis of lower polarizing plate, 30 denotes Upper polarizing plate, 31 denotes VA-Mode liquid crystal cell, 32 denotes Lower polarizing plate, 33 denotes Cellulose acylate film, and 34 denotes Polarizer.

### DETAILED DESCRIPTION OF THE INVENTION

The present invention is described in detail below. In the following, the present invention is described by referring to a film comprising a cellulose acylate as the main component (cellulose acylate film), which is a particularly suitable polymer film of the present invention.

### <Cellulose Acylate Film>

The cellulose acylate film of the present invention is characterized in that the orientation degree of the cellulose acylate molecular chain is specified.

The orientation degree of the cellulose acylate molecular chain in the film can be described using two parameters.

First is the orientation degree in the film in-plane direction (hereinafter, in-plane orientation degree), and hereinafter an in-plane orientation degree in the film surface may be referred to as Pₒ and an average in-plane orientation degree in the entire film thickness may be referred to as Pₜ. Second is the orientation degree in the film thickness direction (hereinafter, out-plane orientation degree Q). Assuming that the stretching direction of the film is x direction, the thickness direction of the film is z direction, and the direction perpendicular to both the x direction and the z direction is y direction, the in-plane orientation degree indicates the orientation degree of the cellulose acylate molecular chain on the xy surface, and the out-plane orientation degree indicates the orientation degree of the cellulose acylate molecular chain on the xz surface.

The in-plane orientation degree is described in detail below.

In the cellulose acylate film of the present invention, the average in-plane orientation degree Pₜ of the cellulose acylate molecular chain in the entire film thickness must satisfy the relationship of the following formula (1) and preferably satisfies the relationship of the following formula (1-2):

0.025≦Pₜ≦0.100 Formula (1)

0.030≦Pₜ≦0.065 Formula (1-2)

Furthermore, the in-plane orientation degree Pₒ of the cellulose acylate molecular chain in the film surface and the average in-plane orientation degree Pₜ of the cellulose acylate molecular chain in the entire film thickness must satisfy the relationship of the following formula (2) and preferably satisfies the relationship of the following formula (2-2):

0.90≦Pₒ/Pₜ≦0.99 Formula (2)

0.95≦Pₒ/Pₜ≦0.97 Formula (2-2)

In the present invention, the film surface indicates the region from the air-solid interface between film and air to a depth of 10 μm.

The in-plane orientation degree (orientation order parameter) Pₒ of the polymer molecular chain in the film surface can be calculated according to the following formula (11) from the peak intensity of 2θ_{χ}/Φ=6 to 11° detected using a thin-film X-ray in-plane measurement by rotating the X-ray detector and the sample at angles of 2θ_{χ}and Φ.

$${P}_{o} = ( 3 {cos}^{2} β - 1 ) / 2 \\ wherein \\ {cos}^{2} β = {\int }_{0}^{π} {cos}^{2} β \cdot I ( β ) \cdot sin β d β / {\int }_{0}^{π} I ( β ) \cdot sin β d β \qquad Formula ( 11 )$$

The average in-plane orientation degree Pₜ of the polymer molecular chain in the entire film thickness can be determined using the formula above from the average value of peak intensity of 2θ=6 to 11° in the transmission two-dimensional X-ray measurement.

The out-plane orientation degree Q is described below.

The out-plane orientation degree Q is determined as follows. A cross-sectional plane parallel to the xz plane of the film is divided into five equal parts over the region from support side to air interface side which are positions at the film formation, the orientation degree in the film cross-sectional plane at each portion is measured using an X-ray beam at several μm to tens of μm, and the average value of out-plane orientation degrees in the thickness direction Qₘ and the fluctuation coefficient of the out-plane orientation degree Q_{f} are measured.

In the cellulose acylate film of the present invention, it is preferred that Qₘ, the average value of out-plane orientation degree Q in the film thickness direction, satisfies the relationship of the following formula (3) and the fluctuation coefficient of the out-plane orientation degree Q_{f}, represented by the following formula (A), satisfies the relationship of the following formula (4):

0.070≦Qₘ≦0.150 Formula (3)

0.01%≦Q_{f}≦5%, Formula (4)

Q_{f}=100×(maximum value of Q−minimum value of Q)/Qₘ. Formula (A)

Qₘ is more preferably from 0.080 to 0.140, and most preferably from 0.100 to 0.130. Also, Q_{f} is more preferably from 0.01 to 3%, and most preferably from 0.01 to 1%.

The average value of out-plane orientation degrees in the film thickness direction indicates an average value of out-plane orientation degrees measured at 5 portions in the region from one surface to the opposite surface with respect to the thickness direction.

In the cellulose acylate film of the present invention, the in-plane orientation degree Pₒ, average in-plane orientation degree Pₜ and average value of out-plane orientation degree Qₘ can be adjusted by stretching the film which contains a solvent of from 0.01 to 4 mass % at a stretching temperature of from glass transition temperature of the film to glass transition temperature of the polymer film+30° C. and at a stretching rate of from 80%/min to 190%/min. The cellulose acylate film of the present invention is described in detail below.

### [Cellulose Acylate]

The cellulose acylate for use in the present invention is described below.

The fundamental principle of the synthesis method for a cellulose acylate is described in Migita et al., Mokuzai Kagaku (Wood Chemistry), pp. 180-190, Kyoritsu Shuppan (1968). A representative synthesis method is a liquid phase-acetylation process using a system of carboxylic acid anhydride-acetic acid-sulfuric acid catalyst. More specifically, a cellulose raw material such as cotton linter and wood pulp is pretreated with an appropriate amount of acetic acid, charged into a previously cooled carboxylation mixture and esterified, whereby a complete cellulose acylate (the total acyl substitution degree at 2-, 3- and 6-positions is almost 3.00) is synthesized. The carboxylation mixture generally comprises an organic acid as the solvent, a carboxylic acid anhydride as the esterifying agent, and a sulfuric acid as the catalyst. The carboxylic acid anhydride is usually used in an amount stoichiometrically in excess of the total amount of cellulose to react therewith and water present in the system. After the completion of acylation reaction, an aqueous solution of a neutralizing agent (for example, a carbonate, an acetate or an oxide of calcium, magnesium, iron, aluminum or zinc) is added to hydrolyze the excess carboxylic acid anhydride remaining in the system and neutralize a part of the esterification catalyst. The complete cellulose acylate obtained is kept at 50 to 90° C. in the presence of a small amount of an acetylation catalyst (generally, the remaining sulfuric acid) to effect saponification ripening until a cellulose acylate having the desired acetyl substitution degree and polymerization degree is obtained. At the point where the desired cellulose acylate is obtained, the catalyst remaining in the system is completely neutralized using the above-described neutralizing agent or is not neutralized, the cellulose acylate solution is poured into water or dilute sulfuric acid (alternatively, water or dilute sulfuric acid is poured into the cellulose acylate solution) to separate a cellulose acylate, and the cellulose acylate separated is then washed and stabilized to obtain the cellulose acylate.

In the cellulose acylate film of the present invention, the polymer constituting the film is preferably composed of substantially the preferred cellulose acylate described above. The “substantially” means to account for 55 mass % or more (preferably 70 mass % or more, more preferably 80 mass % or more) of the polymer component.

As regards the raw material for the film production, a cellulose acylate particle is preferably used. Out of the particles used, 90 mass % or more preferably has a particle diameter of 0.5 to 5 mm, and 50 mass % or more preferably has a particle diameter of 1 to 4 mm. The cellulose acylate particle preferably has a shape close to sphere as much as possible.

The polymerization degree of the cellulose acylate preferably used in the present invention is, in terms of the viscosity average polymerization degree, preferably from 200 to 700, more preferably from 250 to 550, still more preferably from 250 to 400, yet still more preferably from 250 to 350. The average polymerization degree can be measured according to the intrinsic viscosity method proposed by Uda et al. (Kazuo Uda and Hideo Saito, Journal of the Society of Fiber Science and Technology, Japan, Vol. 18, No. 1, pp. 105-120 (1962)). This is also described in detail in JP-A-9-95538.

When low molecular components are removed, the average molecular weight (polymerization degree) becomes high, but the viscosity becomes lower than that of normal cellulose acylate and this cellulose acylate is useful. A cellulose acylate having a small content of low molecular components can be obtained by removing low molecular components from cellulose acylate synthesized by a normal method. The low molecular components can be removed by washing the cellulose acylate with an appropriate organic solvent. Incidentally, in the case of producing a cellulose acylate having a small content of low molecular components, the amount of the sulfuric acid catalyst in the acetylation reaction is preferably adjusted to 0.5 to 25 parts by mass per 100 parts by mass of cellulose. When the amount of the sulfuric acid catalyst is adjusted to this range, a cellulose acylate advantageous also in view of molecular weight distribution (uniform molecular weight distribution) can be synthesized.

In use for the production of the cellulose acylate film of the present invention, the moisture content of the cellulose acylate is preferably 2 mass % or less, more preferably 1 mass % or less, still more preferably 0.7 mass % or less. In general, a cellulose acylate contains moisture and is known to have a moisture content of 2.5 to 5 mass %. In the present invention, in order to obtain this moisture content, the cellulose acylate needs to be dried and the method therefor is not particularly restricted as long as the objective moisture content can be obtained.

As regards such a cellulose acylate for use in the present invention, the raw material cotton and synthesis method are described in detail in JIII Journal of Technical Disclosure, No. 2001-1745, pp. 7-12, Japan Institute of Invention and Innovation (Mar. 15, 2001).

Examples of the cellulose as the raw material of the cellulose acylate for use in the present invention include cotton linter and wood pulp (e.g., hardwood pulp, softwood pulp). A cellulose acylate obtained from either raw material cellulose may be used and depending on the case, a mixture of raw material celluloses may be used. These raw material celluloses are described in detail, for example, in Marusawa and Uda, Plastic Zairyo Koza (17), Seni-kei Jushi (Plastic Material Lecture (17), Fiber-Based Resin), Nikkan Kogyo Shinbun Sha (1970), and JIII Journal of Technical Disclosure, No. 2001-1745, pp. 7-8, and celluloses described therein can be used and are not particularly limited in the application to the cellulose acylate film of the present invention.

As long as the substituent, substitution degree, polymerization degree, molecular weight distribution and the like of the cellulose acylate for use in the present invention are in the above-described ranges, a single cellulose acylate or a mixture of two or more kinds of cellulose acylates may be used.

The cellulose acylate of the present invention is a cellulose of which hydroxyl group is acylated, and the substituent may be any acyl group from an acyl group having a carbon number of 2 (acetyl group) to an acyl group having a carbon number of 22. In the cellulose acylate of the present invention, the substitution degree to the hydroxyl group of cellulose is not particularly limited. The substitution degree can be determined by calculation after measuring the bonding degree of an acetic acid and/or a fatty acid having a carbon number of 3 to 22, substituted to the hydroxyl group of cellulose. As for the measuring method, the measurement may be performed according to ASTM D-817-91.

The cellulose acylate for use in the present invention is preferably a cellulose acetate having an acetylation degree of 2.0 to 2.85. The acetylation degree is more preferably from 2.5 to 2.83.

A cellulose acetate where the substitution ratio at the 6 position represented by the following formula (10) is 0.31 or more and the total substitution degree is 2.85 or less is more preferred.

Substitution ratio at 6-position=substitution degree at 6-position/(substitution degree at 2-position+substitution degree at 3-position+substitution degree at 6-position) Formula (10)

Another preferred cellulose acylate which can be used in the present invention is a cellulose acylate having an acylation degree of 2.0 to 2.85 and having two or more kinds of acyl groups. The carbon number of acyl group is preferably from 2 to 6, and it is more preferred to use an acetyl group, a propionyl group or a butyryl group. Also, when the cellulose acylate film of the present invention has an acetyl group and an acyl group other than the acetyl group, the substitution degree by the acetyl group is preferably less than 2.5, more preferably less than 2.3.

### [Production of Cellulose Acylate Film]

The cellulose acylate film of the present invention is preferably produced through a step of stretching the film which contains a solvent of from 0.01 to 4 mass % at a stretching temperature of from glass transition temperature of the film to glass transition temperature of the polymer film+30° C. and at a stretching rate of from 80%/min to 190%/min. The cellulose acylate film is dried at 120° C. for 2 hours before the stretch, and the solvent content is obtained from mass change through the drying by the following formula:

Solvent Content=(Mass before drying−Mass after drying)/Mass after drying×100

The cellulose acylate in the film produced by solution film formation has a nonuniform orientation in the film thickness direction mainly because the residual solvent comes to have concentration distribution in the film thickness direction at the stretch. That is, the effective glass transition temperature in the area of high solvent concentration decrease more than that in the area of low solvent concentration, and it makes it difficult for the cellulose acylate molecular chain to orient uniformly even in the same stretching ratio.

When the solvent content in the film is from 0.01 to 4 mass %, and the film is stretched at a stretching temperature of from glass transition temperature of the film to glass transition temperature of the polymer film+30° C. and at a stretching rate of from 80%/min to 190%/min, it is possible to stretch the film in the state that the change of effective glass transition temperature in the film thickness direction is small.

By passing through such a stretching step, the conditions of in-plane orientation degree Pₒ, average in-plane orientation degree Pₜ and average value of out-plane orientation degrees in the film thickness direction, which are the requirements of the present invention, can be satisfied.

Also, the cellulose acylate film before stretching preferably satisfies the following conditions (i) and at least one of (ii) and (iii):
(i) the polymer film contains at least two kinds of additives,
(ii) in a concentration distribution in a thickness direction of each of the at least two kinds of additives, a position in the thickness direction exhibiting the minimum concentration differs from each other,
(iii) in the concentration distribution in a thickness direction of each of the at least two kinds of additives, a position in the thickness direction exhibiting the maximum concentration differs from each other.

Incidentally, the solvent content above is a value obtained by drying the cellulose acylate film before stretching, under the conditions of 120° C. and 2 hours and determining the solvent content from the change of mass between before drying and after drying.

The production method of the present invention is described in detail below.

### (Organic Solvent of Cellulose Acylate Solution)

In the present invention, the cellulose acylate film is preferably produced by a solvent casting method, and in this method, the film is produced using a solution (dope) prepared by dissolving a cellulose acylate in an organic solvent. The organic solvent which is preferably used as a main solvent in the present invention is preferably a solvent selected from an ester, ketone or ether having a carbon number of 3 to 12 and a halogenated hydrocarbon having a carbon number of 1 to 7. The ester, ketone and ether each may have a cyclic structure. A compound having two or more functional groups of an ester, a ketone and an ether (that is, —O—, —CO— and —COO—) may also be used as the main solvent, and the compound may have another functional group such as alcoholic hydroxyl group. In the case of a main solvent having two or more kinds of functional groups, the number of carbon atoms may suffice if it falls within the range specified for the compound having any one functional group.

For the cellulose acylate film of the present invention, a chlorine-containing halogenated hydrocarbon may be used as the main solvent or, as described in JIII Journal of Technical Disclosure, No. 2001-1745 (pp. 12-16), a chlorine-free solvent may be used as the main solvent. In this respect, the cellulose acylate film of the present invention is not particularly limited.

Other solvents for the cellulose acylate solution or film of the present invention, including the dissolution method, are described in the following patent publications, and these are preferred embodiments. The solvents are described, for example, in JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752 and JP-A-11-60752. In these patent publications, not only the solvents preferred for the cellulose acylate of the present invention but also their physical properties as a solution and co-existing substances to be present together are described, and these are preferred embodiments also in the present invention.

### (Casting)

Examples of the method for casting the solution include a method of uniformly extruding the prepared dope on a metal support from a pressure die, a doctor blade method of once casting the dope on a metal support and controlling the thickness thereof by using a blade, and a reverse roll coater method of controlling the thickness by using a roll rotating in reverse. Among these, the method using a pressure die is preferred. The pressure die includes a coat hanger die type, a T-die type and the like, and all of these can be preferably used. Other than the methods described above, conventionally known various methods for casting and film-forming a cellulose triacetate solution can be employed, and the same effect as that described in each publication can be obtained by setting respective conditions while taking into account the difference in the boiling point or the like of the solvent used. The endlessly running metal support used in the production of the cellulose acylate film of the present invention is a drum with the surface being mirror-finished by chromium plating or a stainless steel belt (may also be called a band) mirror-finished by surface polishing. As for the pressure die used in the production of the cellulose acylate film of the present invention, one unit or two or more units may be provided above the metal support. The number of units provided is preferably one or two. In the case of providing two or more units, the amount of the dope cast may be divided at various ratios among respective dies, or the dope may be supplied to the dies at respective ratios by a plurality of precision quantitative gear pumps. The temperature of the cellulose acylate solution used for the casting is preferably from −10 to 55° C., more preferably from 25 to 50° C. In this case, the temperature may be the same in all steps or may differ among respective portions of the step. When the temperature differs, it may sufficient if the temperature immediately before casting is a desired temperature.

The drying method in the solvent casting method is described in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554 (the term “JP-B” as used herein means an “examined Japanese patent publication”), JP-B-49-5614, JP-A-60-176834, JP-A-60-203430, and JP-A-62-115035. Drying on the band or drum can be performed by blowing air or an inert gas such as nitrogen.

The obtained cellulose acylate film is separated from the drum or band and may be further dried with hot air by sequentially changing the temperature from 100° C. to 160° C. to evaporate the residual solvent. This method is described in JP-B-5-17844. According to this method, the time from casting to separation can be shortened. In order to practice this method, the dope needs to be gelled at the surface temperature of the drum or band during casting.

The film may also be formed by casting the prepared cellulose acylate solution (dope) in two or more layers. In this case, the cellulose acylate film is preferably produced by a solvent casting method. The dope is cast on a drum or a band and the solvent is evaporated to form a film. The concentration of the dope before casting is preferably adjusted to have a solid content of 10 to 40%. The surface of the drum or band is preferably finished in a mirror state.

In the case of casting the cellulose acylate solution in a plurality of layers of two or more layers, a plurality of cellulose acetate solutions can be cast, and the film may be produced while stacking the layers one on another by casting respective cellulose acylate-containing solutions from a plurality of casting ports provided at intervals in the support travelling direction. This casting can be performed using the method described, for example, in JP-A-61-158414, JP-A-1-122419 and JP-A-11-198285. Also, a film can be formed by casting the cellulose acetate solution from two casting ports. For example, the methods described in JP-B-60-27562, JP-A-61-94724, JP-A-61-947245, JP-A-61-104813, JP-A-61-158413 and JP-A-6-134933 may be used. Furthermore, the casting method of a cellulose acetate film described in JP-A-56-162617 may also be used, where a flow of high-viscosity cellulose acetate solution is enveloped with a low-viscosity cellulose acetate solution and the high-viscosity and low-viscosity cellulose acetate solutions are simultaneously extruded.

In addition, the film can also be produced using two casting ports by separating the film cast from a first casting dye and formed on a support and performing the second casting on the side which had been in contact with the support surface. For example, the method described in JP-B-44-20235 may be used.

The cellulose acylate solutions cast may be the same solution, or different cellulose acylate solutions may be used. In order to impart functions to a plurality of cellulose acylate layers, a cellulose acylate solution according to the function may be extruded from each casting port. The cellulose acylate solution for use in the present invention may also be cast simultaneously with other functional layers (for example, adhesive layer, dye layer, antistatic layer, antihalation layer, ultraviolet absorbing layer and polarizing layer).

Many of conventional single-layer solutions have a problem that a cellulose acylate solution having a high concentration and a high viscosity must be extruded so as to obtain a required film thickness and in this case, the cellulose acylate solution has bad stability and allows for generation of a solid matter to cause particle failure or poor planarity. For solving this problem, a plurality of cellulose acylate solutions are cast from casting ports, whereby high-viscosity solutions can be simultaneously extruded on a support and not only the planarity can be enhanced to give a film having excellent surface state but also by virtue of use of thick cellulose acylate solutions, reduction of the drying load and elevation of the film production speed can be achieved.

### [Stretching Treatment]

In the production method of the cellulose acylate film of the present invention, the cellulose acylate film is subjected to a stretching treatment. A desired retardation can be imparted to the cellulose acylate film by the stretching treatment. As for the stretching direction of the cellulose acylate film, either the width direction or the longitudinal direction is preferred, but the width direction is more preferred.

The stretching method in the width direction is described, for example, in JP-A-62-115035, JP-A-4-152125, JP-A-4-284211, JP-A-4-298310 and JP-A-11-48271. In the case of stretching in the longitudinal direction, for example, the film can be stretched by adjusting the speed of the film conveying roller to make the film take-up speed higher than the film separation speed. In the case of stretching in the width direction, the film can be stretched also by conveying the film while holding the film width by a tenter, and gradually increasing the width of the tenter. The film may also be stretched after drying, by using a stretching machine (preferably uniaxial stretching using a long stretching machine).

The cellulose acylate film of the present invention is preferably stretched in the state of having a residual solvent amount not more than a fixed value at a given stretching rate. The residual solvent content at the stretching is from 0.01 to 4 mass %, preferably from 0.01 to 3 mass %, more preferably from 0.01 to 1 mass %.

In the production method of the cellulose acylate film of the present invention, the stretching is performed under the conditions of the following formulae (8) and (9):

Glass transition temperature of film≦stretching temperature≦(glass transition temperature of film+30° C.) Formula (8)

80%/min≦stretching rate≦190%/min Formula (9)

Formula (8) is preferably formula (8-1), more preferably formula (8-2).

Formula (9) is preferably formula (9-1), more preferably formula (9-2).

(Glass transition temperature of film+5° C.)≦stretching temperature≦(glass transition temperature of film+30° C.) Formula (8-1)

(Glass transition temperature of film+10° C.)≦stretching temperature≦(glass transition temperature of film+25° C.) Formula (8-2)

100%/min≦stretching rate≦180%/min Formula (9-1)

120%/min≦stretching rate≦160%/min Formula (9-2)

Here, the % indication in the stretching rate indicates the stretch ratio.

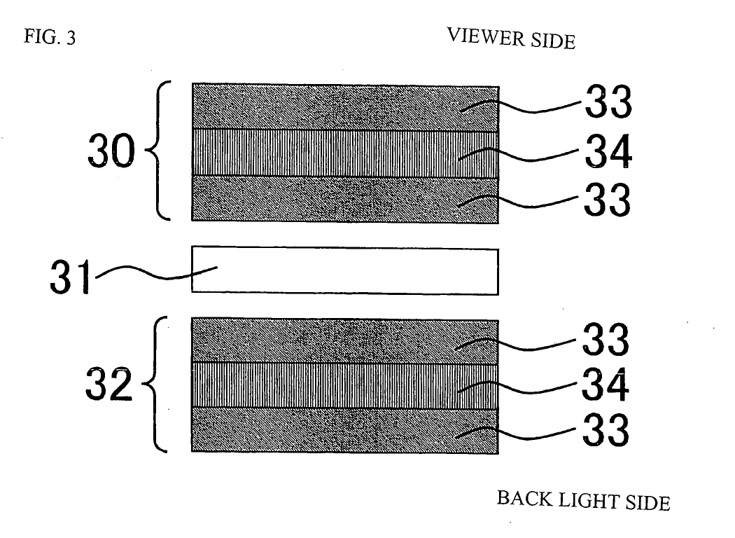

The glass transition temperature in formulae (8), (8-1) and (8-2) above is determined by moisture-conditioning a film sample of 5 mm×30 mm at 25° C.-60% RH for 2 hours or more and then measuring the glass transition temperature by a dynamic viscoelasticity meter (Vibron: DVA-225, (manufactured by IT Keisoku Seigyo K.K.) under the conditions of a gripping distance of 20 mm, a temperature rising rate of 2° C./min, a measurement temperature range of 30 to 200° C. and a frequency of 1 Hz. The storage modulus is taken as a logarithmic axis on the ordinate, the temperature is taken as a linear axis on the abscissa, and with respect to the abrupt decrease of the storage modulus, which is observed when the storage modulus shifts from the solid region to the glass transition region, the glass transition temperature Tg is determined by the method described in JIS K7121-1987, FIG. 3.

The residual solvent content, stretching rate and stretching temperature each is set to the range above, whereby a cellulose acylate film reduced in the fluctuation of in-plane orientation degree and out-plane orientation degree of the cellulose acylate molecular chain in the thickness direction and assured of high retardation developability and small haze can be obtained.

### [Additives]

The cellulose acylate film of the present invention preferably contains additives such as plasticizer, retardation developer, retardation decreasing agent and ultraviolet absorbent.

### (Retardation Developer)

As for the retardation developer, the compounds described, for example, in JP-A-2001-166144, JP-A-2002-363343, JP-A-2003-344655 and JP-A-2005-272685 can be preferably used.

### (Ultraviolet Absorbent)

The cellulose acylate film of the present invention may contain an ultraviolet absorbent.

Examples of the ultraviolet absorbent include an oxybenzophenone-based compound, a benzotriazole-based compound, a salicylic acid ester-based compound, a benzophenone-based compound, a cyanoacrylate-based compound and a nickel complex salt-based compound, but a benzotriazole-based compound giving less coloration is preferred. The ultraviolet absorbents described in JP-A-10-182621 and JP-A-8-337574, and the polymer ultraviolet absorbents described in JP-A-6-148430 may also be preferably used. In the case of using the cellulose acylate film of the present invention as a protective film of a polarizing plate, the ultraviolet absorbent is preferably an ultraviolet absorbent having excellent ability of absorbing an ultraviolet ray at a wavelength of 370 nm or less from the standpoint of preventing deterioration of polarizer or liquid crystal, and at the same time, having less absorption of visible light at a wavelength of 400 nm or more in view of liquid crystal display property.

Specific examples of the benzotriazole-based ultraviolet absorbent useful in the present invention include 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-[2′-hydroxy-3′-(3″,4″,5″,6″-tetrahydrophthalimidomethyl)-5′-methylphenyl]benzotriazole, 2,2-methylenebis[4-(1,1,3,3-tetramethylbutyl)-6-(2H-benzotriazol-2-yl)phenol], 2-(2′-hydroxy-3′-tert-butyl-5′-methylphenyl)-5-chlorobenzo-triazole, 2-(2H-benzotriazol-2-yl)-6-(linear and side-chain dodecyl)-4-methylphenol, and a mixture of octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate, but the present invention is not limited thereto.

Also, as the commercial product, “TINUVIN 109”, “TINUVIN 171”, “TINUVIN 326” and “TINUVIN 328” {all produced by Ciba Specialty Chemicals Corp.)

### (Plasticizer)

The film of the present invention preferably contains a plasticizer. The plasticizer which can be used is not particularly limited, but plasticizers more hydrophobic than cellulose acylate, for example, a phosphoric acid ester-based plasticizer such as triphenyl phosphate, tricresyl phosphate, cresyl diphenyl phosphate, octyl diphenyl phosphate, diphenyl biphenyl phosphate, trioctyl phosphate and tributyl phosphate, a carboxylic acid ester-based plasticizer such as diethyl phthalate, dimethoxyethyl phthalate, dimethyl phthalate, dioctyl phthalate, dibutyl phthalate and di-2-ethylhexyl phthalate, and a glycolic acid ester-based plasticizer such as triacetin, tributyrin, butylphthalyl butyl glycolate, ethylphthalyl ethyl glycolate, methylphthalyl ethyl glycolate and butylphthalyl butyl glycolate, are preferably used individually or in combination. If desired, two or more kinds of plasticizers may be used in combination.

### (Retardation Decreasing Agent)

In the film of the present invention, a retardation decreasing agent may be used. As regards the retardation decreasing agent for use in the present invention, the compounds described in JP-A-2006-30937, paragraphs [0056] to [0114], can be preferably used.

The additive added to the cellulose acylate film of the present invention is added in an amount of 0.1 to 30 mass %, preferably from 0.5 to 20 mass %, more preferably from 1 to 15 mass %, based on the cellulose. In the case of using two or more kinds of additives, the total amount thereof preferably satisfies the above-described range.

The concentration distribution in the thickness direction of the additive affects the uniformity in the thickness direction of the orientation degree of the cellulose acylate film. In the case where two or more kinds of additives are contained, in the concentration distribution of the additive in the thickness direction of the cellulose acylate film of the present invention, the positions in the thickness direction, where at least two kinds of additives exhibit a minimum concentration and/or a maximum concentration, differ from each other between different kinds of additives. According to this embodiment, the effect of each additive on the orientation of the cellulose acylate molecular chain at the stretching is averaged, and a cellulose acylate film assured of high uniformity of the orientation in the thickness direction can be obtained. The expression “positions in the thickness direction differ” as used herein means that when the cellulose acylate film is equally divided into 5 parts in the thickness direction, the minimum concentrations and/or maximum concentrations of different additives are not overlapped in the same division unit. However, when three or more kinds of additives are contained, the concentration distribution is sufficient if at least two kinds of additives are not present in the same division unit above, and it is not meant that three or more kinds of additives all must be present in different division units.

In the cellulose acylate film of the present invention, as regards the concentration distribution of the additive in the thickness direction, at least one additive preferably has a fluctuation coefficient of concentration in the thickness direction of from 0.1% to 100%, represented by the following formula (12).

Fluctuation coefficient of concentration in thickness direction=(maximum concentration−minimum concentration)/average concentration×100 (%) Formula (12)

The fluctuation coefficient of concentration in the thickness direction is more preferably from 5 to 70%, and most preferably from 5 to 50%.

The concentration distribution of the additive in the thickness direction can be determined by cutting out a cross-sectional plane parallel to the xz plane of the film, performing measurement by a time-of-flight secondary ion mass spectrometer (TOF-SIMS) in each portion of the cross-sectional plane, and taking an intensity ratio between the positive ion peak m/Z=109 (C₆H₅O₂⁺) assigned to the decomposition product of cellulose acylate and the peak of molecule+H⁺ ion of the additive or the peak assigned to the decomposition product of the additive.

In the solution film formation, the concentration distribution of the additive in the thickness direction can be generally adjusted by the affinity of the additive for polymer and solvent and the drying rate on the support.

### [Various Properties of Cellulose Acylate Film]

### (Thickness of Cellulose Acylate Film)

The thickness of the cellulose acylate film of the present invention is preferably from 20 to 100 μm, more preferably from 30 to 90 μm.

### (Retardation of Film)

In the present invention, Re(λ) and Rth(λ) indicate the in-plane retardation and the retardation in the thickness direction, respectively, at a wavelength of λ. Re(λ) is measured by making light at a wavelength of λ nm to be incident in the film normal direction in KOBRA 21ADH or WR (manufactured by Oji Scientific Instruments).

In the case where the film measured is a film expressed by a uniaxial or biaxial refractive index ellipsoid, the Rth(λ) is calculated by the following method.

The above-described Re(λ) is measured at 6 points in total by making light at a wavelength of λ nm to be incident from directions inclined with respect to the film normal direction in 10° steps up to 50° on one side from the normal direction with the inclination axis (rotation axis) being the in-plane slow axis (judged by KOBRA 21ADH or WR) (when the slow axis is not present, an arbitrary direction in the film plane is used as the rotation axis) and based on the retardation values measured, assumed values of average refractive index and film thickness values input, Rth(λ) is calculated by KOBRA 21ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21ADH or WR after converting its sign into a negative sign.

Incidentally, after measuring the retardation values from two arbitrary inclined directions by using the slow axis as the inclination axis (rotation axis) (when the slow axis is not present, an arbitrary direction in the film plane is used as the rotation axis), based on the values obtained, assumed values of average refractive index and film thickness values input, Rth can also be calculated according to the following formulae (21) and (22).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 21 )$$

### Note:

Re(θ) above represents a retardation value in the direction inclined at an angle of θ from the normal direction. In formula (21), nx represents the refractive index in the in-plane slow axis direction, ny represents the refractive index in the direction crossing with nx at right angles in the plane, and nz represents the refractive index in the direction crossing with nx and ny at right angles.

Rth=((nx+ny)/2−nz)×d Formula (22)

In the case where the film measured is a film incapable of being expressed by a uniaxial or biaxial refractive index ellipsoid or a film not having a so-called optic axis, Rth(λ) is calculated by the following method.

The Re(λ) is measured at 11 points by making light at a wavelength of λ nm to be incident from directions inclined with respect the film normal direction in 10° steps from −50° to +50° with the inclination axis (rotation axis) being the in-plane slow axis (judged by KOBRA 21ADH or WR) and based on the retardation values measured, assumed values of average refractive index and film thickness values input, Rth(λ) is calculated by KOBRA 21ADH or WR.

In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

The Re(590) of the cellulose acylate film of the present invention is preferably from 20 to 200 nm, more preferably from 30 to 150 nm, and the Rth(590) is preferably from 70 to 400 nm, more preferably from 50 to 400 nm, still more preferably from 100 to 300 nm.

The ratio Rth(590)/Re(590) is preferably from 1 to 10, more preferably from 1.5 to 8.

In use for OCB mode and TN mode, the cellulose acylate film having the retardation values above can be used as an optically-compensatory film by coating an optically anisotropic layer on the cellulose acylate film.

### <Haze of Film>

The haze of the cellulose acylate film of the present invention is preferably from 0.01 to 0.8%, more preferably from 0.05 to 0.7%. If the haze exceeds 0.8%, the contrast of a liquid crystal display device seriously decreases. The optical performance is more excellent as the haze is lower, but when selection of raw materials or production control is also taken into account, the haze is preferably in the above-described range.

In the measurement of haze, a cellulose acylate film sample of 40 mm×80 mm of the present invention is measured according to JIS K-7136 by a haze meter (HGM-2DP, manufactured by Suga Test Instruments Co., Ltd.) at 25° C. and 60% RH.

### [Saponification Treatment]

The cellulose acylate film of the present invention can be imparted with adhesion to the polyvinyl alcohol and used as a polarizing plate protective film by subjecting it to an alkali saponification treatment.

The alkali saponification treatment of the cellulose acylate film is preferably performed by a cycle consisting of dipping of the film surface in an alkali solution, neutralization with an acidic solution, water-washing and drying. The alkali solution includes a potassium hydroxide solution and a sodium hydroxide solution, and the hydroxide ion normal concentration is preferably from 0.1 to 5.0 N, more preferably from 0.5 to 4.0 N. The temperature of the alkali solution is preferably from room temperature to 90° C., more preferably from 40 to 70° C.

### (Polarizing Plate)

The polarizing plate is composed of a polarizer and two transparent protective films disposed on both sides of the polarizer. The cellulose acylate film of the present invention can be used as one protective film. As for the other protective film, a normal cellulose acetate film may be used. The polarizer includes an iodine-based polarizer, a dye-based polarizer using a dichromatic dye, and a polyene-based polarizer. The iodine-based polarizer and dye-based polarizer are generally produced using a polyvinyl alcohol-based film. In the case of using the cellulose acylate film of the present invention as the polarizing plate protective film, the polarizing plate is not particularly limited in its production method and can be produced by a general method. There is known a method where the obtained cellulose acylate film is alkali-treated and laminated using an aqueous solution of completely saponified polyvinyl alcohol on both surfaces of a polarizer obtained by dipping a polyvinyl alcohol film in an iodine solution and stretching it. Instead of the alkali treatment, a process for easy adhesion described in JP-A-6-94915 and JP-A-6-118232 may be applied. Examples of the adhesive used for laminating the treated surface of the protective film to the polarizer include a polyvinyl alcohol-based adhesive such as polyvinyl alcohol and polyvinyl butyral, and a vinyl-based latex such as butyl acrylate. The polarizing plate is composed of a polarizer and protective films protecting both surfaces of the polarizer and is constituted by further laminating a protect film to one surface of the polarizing plate and a separate film to the opposite surface. The protect film and separate film are used for the purpose of protecting the polarizing plate, for example, at the shipment of polarizing plate or at the inspection of product. In this case, the protect film is laminated for the purpose of protecting the polarizing plate surface and used on the surface opposite the surface through which the polarizing plate is laminated to a liquid crystal plate. The separate film is used for the purpose of covering the adhesive layer which is laminated to a liquid crystal plate and used on the surface through which the polarizing plate is laminated to a liquid crystal plate.

The cellulose acylate film of the present invention is preferably laminated to a polarizer such that the transmission axis of the polarizer agrees with the slow axis of the cellulose acylate film of the present invention. Incidentally, when a polarizing plate produced as a polarizing plate in the cross-Nicol state is evaluated, it is found that if the orthogonality precision between the slow axis of the cellulose acylate film of the present invention and the absorption axis (axis crossing the transmission axis at right angles) of the polarizer exceeds 1°, the polarization degree performance as a polarizing plate in the cross-Nicol state decreases and light leakage occurs. In this case, when combined with a liquid crystal cell, a sufficiently high black level or contrast cannot be obtained. Accordingly, the slippage between the main refractive index nx direction of the cellulose acylate film of the present invention and the transmission axis direction of the polarizing plate is preferably within 10, preferably within 0.5°.

The single plate transmittance TT, parallel transmittance PT and cross transmittance CT of the polarizing plate are measured in the range of 380 to 780 nm by using UV3100PC (manufactured by Shimadzu Corporation), and an average value of 10 measurements is used for all of the single plate, parallel and cross transmittances. The endurance test of the polarizing plate is performed as follows in two modes, that is, (1) a polarizing plate alone and (2) a polarizing plate laminated to a glass through a pressure-sensitive adhesive. In the measurement of a polarizing plate alone, polarizing plates are combined such that the optically-compensatory film is sandwiched between two polarizers, and two samples having the same crossing are prepared and measured. In the case of the glass lamination mode, the polarizing plate is laminated on a glass such that the optically-compensatory film comes to the glass side, and two samples (about 5 cm×5 cm) are prepared. The single plate transmittance is measured by setting the film side of this sample to face the light source. Two samples are measured, and the average value thereof is used as the single plate transmittance. As for the polarizing performance, the single plate transmittance TT, parallel transmittance PT and cross transmittance CT are, in this order, 40.0≦TT≦45.0, 30.0≦PT≦40.0 and CT≦2.0, preferably 41.0≦TT≦44.5, 34≦PT≦39.0 and CT≦1.3 (unit: % in all). In the endurance test of the polarizing plate, the change amount thereof is preferably smaller.

When the polarizing plate of the present invention is left standing still for 500 hours under the conditions of 60° C. and 95% RH, the change amount ΔCT (%) of the cross single plate transmittance and the change amount ΔP of the polarization degree preferably satisfy at least one of the following formulae (j) and (k):

−6.0≦ΔCT≦6.0 (j)

−10.0≦ΔP≦0.0 (k)

Here, the change amount indicates a value obtained by subtracting the measured value before test from the measured value after test.

By satisfying this requirement, the stability of the polarizing plate in use or during storage can be ensured.

In the polarizing plate according to the present invention, an optically anisotropic layer is preferably provided on the protective film.

The material for the optically anisotropic layer is not particularly limited and, for example, a liquid crystalline compound, a non-liquid crystalline compound, an inorganic compound, or an organic/inorganic complex compound may be used. The liquid crystalline compound may be a compound used by aligning a low-molecule compound having a polymerizable group and fixing the alignment through polymerization under the action of light or heat, or a compound used by heating and aligning a liquid crystal polymer and then cooling and fixing the alignment in the glass state. As for the liquid crystalline compound, those having a discotic structure, a rod-like structure or a structure showing optical biaxiality may be used. As for the non-liquid crystalline compound, a polymer having an aromatic ring, such as polyimide and polyester, may be used.

The optically anisotropic layer may be formed using various methods such as coating, vapor deposition and sputtering.

In the case of providing an optically anisotropic layer on the protective film of the polarizing plate, the adhesive layer is provided on the outer side of the optically anisotropic layer more remote from the polarizer side.

As for the film (substrate) of the present invention or the optical film using it and excluding the above-described polarizing plate, for example, the following functional optical film may be constructed.

### [Layer Construction of Functional Optical Film]

The functional optical film can be produced by providing a single functional layer or a plurality of functional layers, which is (are) required according to the purpose, on a transparent substrate (also referred to as a support).

One preferred embodiment is an antireflection film where layers are stacked on a substrate by taking into account the refractive index, film thickness, number of layers, order of layers, and the like so as to reduce the reflectance by the effect of optical interference. The simplest construction of the antireflection film is a construction where only a low refractive index layer is provided by coating on a substrate. In order to more reduce the reflectance, the antireflection layer is preferably constituted by combining a high refractive index layer having a refractive index higher than that of the substrate and a low refractive index layer having a refractive index lower than that of the substrate. Examples of the construction include a two-layer construction of high refractive index layer/low refractive index layer from the substrate side, and a construction formed by stacking three layers differing in the refractive index in the order of a medium refractive index layer (a layer having a refractive index higher than that of the substrate or hardcoat layer but lower than that of the high refractive index layer)/a high refractive index layer/a low refractive index layer. Also, a construction where a larger number of antireflection layers are stacked has been proposed. Above all, in view of the durability, optical property, cost, productivity and the like, it is preferred to coat a medium refractive index layer/a high refractive index layer/a low refractive index layer in this order on a substrate having thereon a hardcoat layer. Examples thereof include the constructions described in JP-A-8-122504, JP-A-8-110401, JP-A-10-300902, JP-A-2002-243906 and JP-A-2000-111706.

Other functions may be imparted to each layer, and examples of such a layer include an antifouling low refractive index layer and an antistatic high refractive index layer (see, for example, JP-A-10-206603 and JP-A-2002-243906).

Preferred examples of the layer construction of the antireflection film include the followings. The antireflection film is not limited to these layer constructions as long as the reflectance can be reduced by optical interference. In the constructions below, the substrate film indicates the support composed of a film.

Substrate film/low refractive index layer

Substrate film/antistatic layer/low refractive index layer

Substrate film/antiglare layer/low refractive index layer

Substrate film/antiglare layer/antistatic layer/low refractive index layer

Substrate film/hardcoat layer/antiglare layer/low refractive index layer

Substrate film/hardcoat layer/antiglare layer/antistatic layer/low refractive index layer

Substrate film/hardcoat layer/antistatic layer/antiglare layer/low refractive index layer

Substrate film/hardcoat layer/high refractive index layer/low refractive index layer

Substrate film/hardcoat layer/antistatic layer/high refractive index layer/low refractive index layer

Substrate film/hardcoat layer/medium refractive index layer/high refractive index layer/low refractive index layer

Substrate film/antiglare layer/high refractive index layer/low refractive index layer

Substrate film/antiglare layer/medium refractive index layer/high refractive index layer/low refractive index layer

Substrate film/antistatic layer/hardcoat layer/medium refractive index layer/high refractive index layer/low refractive index layer

Antistatic layer/substrate film/hardcoat layer/medium refractive index layer/high refractive index layer/low refractive index layer

Substrate film/antistatic layer/antiglare layer/medium refractive index layer/high refractive index layer/low refractive index layer

Antistatic layer/substrate film/antiglare layer/medium refractive index layer/high refractive index layer/low refractive index layer

Antistatic layer/substrate film/antiglare layer/high refractive index layer/low refractive index layer/high refractive index layer/low refractive index layer

Another preferred embodiment is a functional optical film which does not aggressively use the optical interference and in which layers necessary for imparting hardcoat property, moisture resistance, gas barrier property, antiglare property, antifouling property and the like are provided.

Examples of the preferred layer construction of the film in the embodiment above include the followings. In the constructions below, the substrate film indicates support composed of a film

Substrate film/hardcoat layer

Substrate film/hardcoat layer/hardcoat layer

Substrate film/antiglare layer

Substrate film/antiglare layer/antiglare layer

Substrate film/hardcoat layer/antiglare layer

Substrate film/antiglare layer/hardcoat layer

Substrate film/antistatic layer

Substrate film/antistatic layer/hardcoat layer

Substrate film/moisture-resistant layer

Substrate film/gas barrier layer

Substrate film/hardcoat layer/antifouling layer

Antistatic layer/substrate film/hardcoat layer

Antistatic layer/substrate film/antiglare layer

Antiglare layer/substrate film/antistatic layer

These layers can be formed by a method such as vapor deposition, atmospheric pressure plasma and coating. In view productivity, the layers are preferably formed by coating.

Each constituent layer is described below.

### 2-(1) Hardcoat Layer

In the film of the present invention, a hardcoat layer may be provided preferably on one surface thereof so as to impart physical strength to the film. The hardcoat layer may be composed of a stack of two or more layers.

In the present invention, in view of optical design for obtaining an antireflection film, the refractive index of the hardcoat layer is preferably from 1.48 to 2.00, more preferably from 1.52 to 1.90, still more preferably from 1.55 to 1.80. In the embodiment where at least one layer of low refractive index layer is present on the hardcoat layer, which is a preferred embodiment of the present invention, if the refractive index is smaller than the above-described range, the antireflection property may decrease, whereas if it is excessively large, the color tint of reflected light tends to be intensified.

From the standpoint of imparting satisfactory durability and impact resistance to the film, the thickness of the hardcoat layer is usually on the order of 0.5 to 50 μm, preferably from 1 to 20 μm, more preferably from 2 to 10 μm, and most preferably from 3 to 7 μm.

The strength of the hardcoat layer is preferably H or more, more preferably 2H or more, and most preferably 3H or more, in the pencil hardness test.

Furthermore, in the Taber test according to JIS K5400, the abrasion loss of the specimen between before and after test is preferably smaller.

The hardcoat layer is preferably formed through a crosslinking or polymerization reaction of an ionizing radiation-curable compound. For example, a coating composition containing an ionizing radiation-curable polyfunctional monomer or polyfunctional oligomer is coated on a transparent support, and a crosslinking reaction or polymerization reaction of the polyfunctional monomer or polyfunctional oligomer is brought about, whereby the hardcoat layer can be formed.

The functional group in the ionizing radiation-curable polyfunctional monomer or polyfunctional oligomer is preferably a photo-, electron beam- or radiation-polymerizable functional group, more preferably a photopolymerizable functional group.

Examples of the photopolymerizable functional group include an unsaturated polymerizable functional group such as (meth)acryloyl group, vinyl group, styryl group and allyl group. Among these, a (meth)acryloyl group is preferred. In place of or in addition to the monomer having a polymerizable unsaturated group, a crosslinking functional group may be introduced into the binder. Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also, a vinylsulfonic acid, an acid anhydride, a cyanoacrylate derivative, a melamine, an etherified methylol, an ester, a urethane, and a metal alkoxide such as tetramethoxysilane can be used as the monomer having a crosslinked structure. A functional group which exhibits crosslinking property as a result of decomposition reaction, such as blocked isocyanate group, may also be used. That is, the crosslinking functional group for use in the present invention may be a functional group which does not directly exhibit a reaction but exhibits reactivity as a result of decomposition. The binder polymer having such a crosslinking functional group is coated and then heated, whereby a crosslinked structure can be formed.

The hardcoat layer may contain a matting particle having an average particle diameter of 1.0 to 15.0 μm, preferably 1.5 to 10.0 μm, such as inorganic compound particle or resin particle, for the purpose of imparting internal scattering property.

For the purpose of controlling the refractive index of the hardcoat layer, a high refractive index monomer or inorganic fine particle or both may be added to the binder of the hardcoat layer. The inorganic fine particle has an effect of suppressing curing shrinkage ascribable to the crosslinking reaction, in addition to the effect of controlling the refractive index. In the present invention, the term “binder” is used including a polymer produced by the polymerization of the polyfunctional monomer and/or the high refractive index monomer or the like after the formation of the hardcoat layer, and the inorganic particle dispersed therein.

The haze of the hardcoat layer varies depending on the function imparted to the functional optical film.

In the case of maintaining the sharpness of image, reducing the reflectance on the surface, and not imparting a light-scattering function in the inside and on the surface of the hardcoat layer, the haze value is preferably lower, specifically, is preferably 10% or less, more preferably 5% or less, and most preferably 2% or less.

On the other hand, in the case of imparting an antiglare function by the surface scattering of the hardcoat layer, the surface haze is preferably from 5 to 15%, more preferably from 5 to 10%.

Furthermore, in the case of imparting a function of making less perceivable the liquid crystal panel pattern, color unevenness, brightness unevenness or glaring by the effect of internal scattering or enlarging the viewing angle by the scattering, the internal haze (a value obtained by subtracting the surface haze value from the entire haze value) is preferably from 10 to 90%, more preferably from 15 to 80%, and most preferably from 20 to 70%.

In the film of the present invention, the surface haze and internal haze can be freely set according to the purpose.

As for the surface irregularity shape of the hardcoat layer, in order to obtain a clear surface for the purpose of maintaining the sharpness of image, for example, the centerline average roughness (Ra) out of characteristics showing the surface roughness is preferably 0.08 μm. Ra is more preferably 0.07 μm or less, still more preferably 0.06 μm or less. In the film of the present invention, the surface irregularities of the film are mainly governed by the surface irregularities of the hardcoat layer and therefore, the centerline average roughness of the antireflection film can be made to fall within the above-described range by adjusting the centerline average roughness of the hardcoat layer.

For the purpose of maintaining the sharpness of image, the transmitted image clarity is preferably adjusted in addition to the adjustment of surface irregularity shape. The transmitted image clarity of a clear antireflection film is preferably 60% or more. The transmitted image clarity is generally an index showing the degree of blurring of an image transmitted through and reflected on the film and as this value is larger, the image viewed through the film is clearer and better. The transmitted image clarity is preferably 70% or more, more preferably 80% or more.

### [Photoinitiator]

Examples of the photoradical polymerization initiator include acetophenones, benzoins, benzophenones, phosphine oxides, ketals, anthraquinones, thioxanthones, azo compounds, peroxides (see, for example, in JP-A-2001-139663), 2,3-dialkyldione compounds, disulfide compounds, fluoroamine compounds, aromatic sulfoniums, lophine dimers, onium salts, borate salts, active esters, active halogens, inorganic complexes and coumarins.

These initiators may be used individually or as a mixture.

Various examples are described in Saishin UV Koka Giiutsu (Latest UV Curing Technologies), page 159, Technical Information Institute Co., Ltd. (1991), and Kiyomi Kato, Shigaisen Koka System (Ultraviolet Curing System), pp. 65-148, Sogo Gijutsu Center (1989), and these are useful in the present invention.

Preferred examples of the commercially available photoradical polymerization initiator include KAYACURE (e.g., DETX-S, BP-100, BDMK, CTX, BMS, 2-EAQ, ABQ, CPTX, EPD, ITX, QTX, BTC, MCA) produced by Nippon Kayaku Co., Ltd.; Irgacure (e.g., 651, 184, 500, 819, 907, 369, 1173, 1870, 2959, 4265, 4263) produced by Ciba Specialty Chemicals Corp.; Esacure (KIP100F, KB1, EB3, BP, X33, KT046, KT37, KIP150, TZT) produced by Sartomer Company Inc.; and a mixture thereof.

The photopolymerization initiator is preferably used in an amount of 0.1 to 15 parts by mass, more preferably from 1 to 10 parts by mass, per 100 parts by mass of the polyfunctional monomer.

### [Surface State Improver]

In order to improve the surface state failure (e.g., coating unevenness, drying unevenness, point defect), at least either a fluorine-based surface improver or a silicone-based surface state improver is preferably added to the coating solution used for the production of any one layer on the support.

The surface state improver preferably changes the surface tension of the coating solution by 1 mN/m or more. Here, the expression “the surface tension of the coating solution changes by 1 mN/m or more” means that the surface tension of the coating solution after the addition of the surface state improver changes, including the concentration process at the coating/drying, by 1 mN/m or more as compared with the surface tension of the coating solution in which the surface state improver is not added. The surface state improver preferably has an effect of decreasing the surface tension of the coating solution by 1 mN/m or more, more preferably by 2 mN/m or more, still more preferably by 3 mN/m or more. Preferred examples of the fluorine-based surface state improver include a compound containing a fluoroaliphatic group. Preferred examples of the compound include the compounds described in JP-A-2005-115359, JP-A-2005-221963 and JP-A-2005-234476.

### 2-(2) Antiglare Layer

The antiglare layer is formed for the purpose of endowing the film with an antiglare property by surface scattering and preferably a hardcoat property to enhance scratch resistance of the film.

As for the method of imparting the antiglare property, known examples thereof include a method of forming the antiglare layer by laminating a matte shaped film having fine irregularities on the surface described in JP-A-6-16851; a method of forming the antiglare layer by varying the irradiation dose of ionizing radiation and thereby bringing out curing shrinkage of an ionizing radiation-curable resin described in JP-A-2000-206317; a method of decreasing through drying the weight ratio of good solvent to light-transparent resin and thereby gelling and solidifying a light-transparent fine particle and a light-transparent resin to form irregularities on the coating film surface described in JP-A-2000-338310; a method of imparting surface irregularities by applying an external pressure described in JP-A-2000-275404; and a method of forming surface irregularities by making use of the phase separation occurring in the process of the solvents evaporating from a mixed solution of a plurality of polymers described in JP-A-2005-195819. These known methods can be utilized.

The antiglare layer which can be used in the present invention is preferably a layer containing, as essential components, a binder capable of imparting hardcoat property, a light-transparent particle for imparting antiglare property, and a solvent, in which surface irregularities are formed by protrusion of the light-transparent particle itself or protrusion created by an aggregate of a plurality of particles.

The antiglare layer formed by the dispersion of matting particles comprises a binder and light-transparent particles dispersed in the binder. The antiglare layer having antiglare property preferably has both antiglare property and hardcoat property.

Specific preferred examples of the matting particle include an inorganic compound particle such as silica particle and TiO₂ particle; and a resin particle such as acryl particle, crosslinked acryl particle, polystyrene particle, crosslinked styrene particle, melamine resin particle and benzoguanamine resin particle. Among these, a crosslinked styrene particle, a crosslinked acryl particle and a silica particle are more preferred. The shape of the matting particle may be either spherical or amorphous.

Also, two or more kinds of matting particles differing in the particle diameter may be used in combination. The matting particle having a larger particle diameter can impart antiglare property and the matting particle having a smaller particle diameter can impart another optical property. For example, when an antiglare antireflection film is laminated on a high-definition display of 133 ppi or more, a trouble in view of display image quality, called “glaring”, is sometimes generated. The “glaring” is ascribable to loss of brightness uniformity resulting from enlargement or shrinkage of a pixel due to irregularities present on the antiglare antireflection film surface, but this can be greatly improved by using together a matting particle having a particle diameter smaller than that of the antiglare property-imparting matting particle and having a refractive index different from that of the binder.

The matting particle is contained in the antiglare layer such that the amount of the matting particle in the formed antiglare hardcoat layer becomes preferably from 10 to 1,000 mg/m², more preferably from 100 to 700 mg/m².

The film thickness of the antiglare layer is preferably from 1 to 20 μm, more preferably from 2 to 10 μm. Within this range, the hardcoat property, curling and brittleness can be satisfied.

The centerline average roughness (Ra) of the antiglare layer is preferably from 0.09 to 0.40 μm. If the centerline average roughness exceeds 0.40 μm, there arises a problem such as glaring or surface whitening due to reflection of outside light. The transmitted image clarity is preferably from 5 to 60%.

The strength of the antiglare layer is preferably H or more, more preferably 2H or more, and most preferably 3H or more, in the pencil hardness test.

### 2-(3) High Refractive Index Layer, Medium Refractive Index Layer

In the film of the present invention, a high refractive index layer and a medium refractive index layer may be provided to enhance the antireflection property by utilizing the optical interference together with the low refractive index layer described later.

In the following, these high refractive index layer and medium refractive index layer are sometimes collectively referred to as a high refractive index layer. Incidentally, in the present invention, the terms “high”, “medium” and “low” in the high refractive index layer, medium refractive index layer and low refractive index indicate the relative size of refractive index among layers. In terms of the relationship with the transparent support, the refractive index preferably satisfies the relationships of transparent support>low refractive index layer, and high refractive index layer>transparent support.

Also, in the present invention, the high refractive layer, medium refractive layer and low refractive index layer are sometimes collectively referred to as an antireflection layer.

For producing an antireflection film by forming a low refractive index layer on a high refractive index layer, the refractive index of the high refractive index layer is preferably from 1.55 to 2.40, more preferably from 1.60 to 2.20, still more preferably from 1.65 to 2.10, and most preferably from 1.80 to 2.00.

In the case of producing an antireflection film by providing a medium refractive index layer, a high refractive index layer and a low refractive index layer in the order of being closer to the support, the refractive index of the high refractive index layer is preferably from 1.65 to 2.40, more preferably from 1.70 to 2.20. The refractive index of the medium refractive index layer is adjusted to a value between the refractive index of the low refractive index layer and the refractive index of the high refractive index layer. The refractive index of the medium refractive index layer is preferably from 1.55 to 1.80.

Specific examples of the inorganic particle for use in the high refractive index layer and medium refractive index layer include TiO₂, ZrO₂, Al₂O₃, In₂O₃, ZnO, SnO₂, Sb₂O₃, ITO and SiO₂. Among these, TiO₂ and ZrO₂ are preferred from the standpoint of elevating the refractive index. It is also preferred to treat the inorganic filler surface by a silane coupling treatment or a titanium coupling treatment. A surface treating agent having a functional group capable of reacting with the binder species on the filler surface is preferably used.

The content of the inorganic particle in the high refractive index layer is preferably from 10 to 90 mass %, more preferably from 15 to 80 mass %, still more preferably from 15 to 75 mass %, based on the mass of the high refractive index layer. Two or more kinds of inorganic particles may be used in combination in the high refractive index layer.

In the case of having a low refractive index layer on the high refractive index layer, the refractive index of the high refractive index layer is preferably higher than the refractive index of the transparent support.

In the high refractive index layer, a binder obtained by a crosslinking or polymerization reaction of an aromatic ring-containing ionizing radiation-curable compound, an ionizing radiation-curable compound containing a halogen element (e.g., Br, I, Cl) except for fluorine, an ionizing radiation-curable compound containing an atom such as S, N and P, or the like may also be preferably used.

The film thickness of the high refractive index layer may be appropriately designed according to the usage. In the case of using the high refractive index layer as an optical interference layer described later, the film thickness is preferably from 30 to 200 nm, more preferably from 50 to 170 nm, still more preferably from 60 to 150 nm.

In the case of not containing an antiglare function-imparting particle, the haze of the high refractive index layer is preferably lower. The haze is preferably 5% or less, more preferably 3% or less, still more preferably 1% or less. The high refractive index layer is preferably formed on the transparent support directly or through another layer.

### 2-(4) Low Refractive Index Layer

For reducing the reflectance of the film of the present invention, a low refractive index layer is preferably used.

The refractive index of the low refractive index layer is preferably from 1.20 to 1.46, more preferably from 1.25 to 1.46, still more preferably from 1.30 to 1.40.

The thickness of the low refractive index layer is preferably from 50 to 200 nm, more preferably from 70 to 100 nm. The haze of the low refractive index layer is preferably 3% or less, more preferably 2% or less, and most preferably 1% or less. The strength of the low refractive index layer is preferably H or more, more preferably 2H or more, and most preferably 3H or more, in the pencil hardness test with a load of 500 g.

In order to improve the antifouling performance of the functional optical film, the contact angle for water on the surface is preferably 90° or more, more preferably 95° or more, still more preferably 100° or more.

Preferred embodiments of the curable composition include (1) a composition containing a fluorine-containing polymer having a crosslinking or polymerizable functional group, (2) a composition containing, as a main component, a hydrolysis condensation product of a fluorine-containing organosilane material, and (3) a composition containing a monomer having two or more ethylenically unsaturated groups and an inorganic fine particle having a hollow structure.

### (1) Fluorine-Containing Compound Having Crosslinking or Polymerizable Functional Group

Examples of the fluorine-containing compound having a crosslinking or polymerizable functional group a copolymer of a fluorine-containing monomer and a monomer having a crosslinking or polymerizable functional group. Examples of the fluorine-containing monomer include fluoroolefins (e.g., fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (e.g., VISCOAT 6FM (produced by Osaka Organic Chemical Industry Ltd.), M-2020 (produced by Daikin Industries, Ltd.)), and completely or partially fluorinated vinyl ethers.

One embodiment of the monomer for imparting a crosslinking group includes a (meth)acrylate monomer previously having a crosslinking functional group within the molecule, such as glycidyl methacrylate. Another embodiment is a method of synthesizing a fluorine-containing copolymer with use of a monomer having a functional group such as hydroxyl group, and further using a monomer for modifying the substituent to introduce a crosslinking or polymerizable functional group. Such a monomer includes a (meth)acrylate monomer having a carboxyl group, a hydroxyl group, an amino group, a sulfo group or the like (for example, (meth)acrylic acid, methylol (meth)acrylate, hydroxyalkyl(meth)acrylate and allyl acrylate. The latter embodiment is disclosed in JP-A-10-25388 and JP-A-10-147739.

In view of solubility, dispersibility, coatability, antifouling property, antistatic property and the like, the above-described fluorine-containing copolymer may appropriately contain a copolymerizable component. Particularly, in order to impart antifouling property/slipperiness, silicone is preferably introduced and may be introduced into either the main chain or the side chain.

Examples of the method for introducing a polysiloxane partial structure into the main chain include a method using a polymer-type initiator such as azo group-containing polysiloxane amide (as the commercial product, VPS-0501 and VPS-1001 (trade names, produced by Wako Pure Chemicals Industries, Ltd.)) described in JP-A-6-93100. Examples of the method for the introduction into the side chain include a method of introducing a polysiloxane having a reactive group at one terminal (for example, Silaplane Series (produced by Chisso Corp.)) through a polymer reaction described in J. Appl. Polym. Sci., 2000, 78 (1955) and JP-A-56-28219, and a method of polymerizing a polysiloxane-containing silicon macromer.

As described in JP-A-2000-17028, a curing agent having a polymerizable unsaturated group may be appropriately used in combination with the above-described polymer. Furthermore, as described in JP-A-2002-145952, use in combination of a compound having a fluorine-containing polyfunctional polymerizable unsaturated group is also preferred. Examples of the compound having a polyfunctional polymerizable unsaturated group include the above-described monomer having two or more ethylenically unsaturated groups. A hydrolysis condensation product of organosilane described in JP-A-2004-170901 is also preferred, and a hydrolysis condensation product of organosilane containing a (meth)acryloyl group is more preferred.

Such a compound, particularly a compound having a polymerizable unsaturated group in the polymer body, is preferred, because the combination use thereof provides a great effect on the improvement of scratch resistance.

In the case where the polymer itself lacks satisfactory curability by itself, the necessary curability can be imparted by blending a crosslinking compound. For example, when the polymer body contains a hydroxyl group, various amino compounds are preferably used as the curing agent. The amino compound used as the crosslinking compound is, for example, a compound having two or more groups in total of either one or both of a hydroxyalkylamino group and an alkoxyalkylamino group, and specific examples thereof include a melamine-based compound, a urea-based compound, a benzoguanamine-based compound and a glycoluril-based compound. Such a compound is preferably cured using an organic acid or a salt thereof.

Specific examples of the fluorine-containing polymer are described in JP-2003-222702 and JP-A-2003-183322.

### (2) Hydrolysis Condensation Product of Fluorine-Containing Organosilane Material

A composition containing, as a main component, a hydrolysis condensation product of a fluorine-containing organosilane compound is also preferred because of its low refractive index and the high hardness of the coating film surface. A condensation product of tetraalkoxysilane with a compound containing a hydrolyzable silanol at one terminal or both terminals with respect to the fluorinated alkyl group is preferred. Specific examples of the composition are described in JP-A-2002-265866 and JP-A-2002-317152.

### (3) Composition Containing Monomer Having Two or More Ethylenically Unsaturated Groups and Having Hollow Structure

Another preferred embodiment includes a low refractive index layer comprising a low refractive index particle and a binder. The low refractive index particle may be organic or inorganic, but a particle having a vacancy in the inside is preferred. Specific examples of the hollow particle are described in the paragraph of silica-based particle of JP-A-2002-79616. The refractive index of the particle is preferably from 1.15 to 1.40, more preferably from 1.20 to 1.30. Examples of the binder include the monomer having two or more ethylenically unsaturated groups.

The polymerization initiator described above in the paragraph of hardcoat layer is preferably added to the low refractive index. In the case of containing a radical polymerizable compound, the polymerization initiator can be used in an amount of 1 to 10 parts by mass, preferably from 1 to 5 parts by mass, based on the compound.

In the low refractive index layer of the present invention, an inorganic particle can be used in combination. In order to impart scratch resistance, a fine particle having a particle diameter corresponding to 15 to 150%, preferably from 30 to 100%, more preferably from 45 to 60%, of the thickness of the low refractive index layer may be used.

In the low refractive index layer of the present invention, for example, a known silicon-based or fluorine-based antifouling agent or slipping agent can be appropriately added for the purpose of imparting properties such as antifouling property, water resistance, chemical resistance and slipperiness.

### 2-(5) Antistatic Layer

In the present invention, an antistatic layer is preferably provided for preventing electrostatic charging on the film surface. Examples of the method for forming an antistatic layer include conventionally known methods such as a method of coating an electrically conducting coating solution containing an electrically conducting fine particle and a reactive curable resin, and a method of vapor-depositing or sputtering a transparent film-forming metal or metal oxide or the like to form an electrically conducting thin film. The antistatic layer may be formed on the support directly or through a primer layer ensuring firm adhesion to the support. Also, the antistatic layer may be used as a part of the antireflection film. In this case, when used as a layer closer to the outermost surface layer, a sufficiently high antistatic property can be obtained even with a small film thickness.

The thickness of the antistatic layer is preferably from 0.01 to 10 μm, more preferably from 0.03 to 7 μm, still more preferably from 0.05 to 5 μm. The surface resistance of the antistatic layer is preferably from 10⁵ to 10¹² Ω/sq, more preferably from 10⁵ to 10⁹ Ω/sq, and most preferably from 10⁵ to 10⁸ Ω/sq. The surface resistance of the antistatic layer can be measured by the four-probe method.

It is preferred that the antistatic layer is substantially transparent. Specifically, the haze of the antistatic layer is preferably 10% or less, more preferably 5% or less, still more preferably 3% or less, and most preferably 1% or less. The transmittance for light at a wavelength of 550 nm is preferably 50% or more, more preferably 60% or more, still more preferably 65% or more, and most preferably 70% or more.

The antistatic layer of the present invention has excellent strength. Specifically, the strength of the antistatic layer is, in terms of the pencil hardness with a load of 1 kg, preferably H or more, more preferably 2H or more, still more preferably 3H or more, and most preferably 4H or more.

### [Coating Solvent]

Out of these constituent layers, the layer coated adjacent to the substrate film preferably contains at least one kind of a solvent capable of dissolving the substrate film and at least one kind of a solvent incapable of dissolving the substrate film. By virtue of such an embodiment, excessive penetration of the components of the adjacent layer into the substrate film can be prevented and at the same time, the adhesion between the adjacent layer and the substrate film can be ensured. Also, at least one kind of a solvent out of the solvents capable of dissolving the substrate film preferably has a boiling point higher than that of at least one kind of a solvent out of the solvents incapable of dissolving the substrate film. More preferably, the difference in the boiling point temperature between the solvent having a highest boiling point out of the solvents capable of dissolving the substrate film and the solvent having a highest boiling point out of the solvents incapable of dissolving the substrate film is 30° C. or more. The difference in the boiling point temperature is most preferably 40° C. or more.

The mass ratio (A/B) of the total amount (A) of the solvents capable of solving the transparent substrate film to the total amount (B) of the solvents incapable of dissolving the transparent substrate film is preferably from 5/95 to 50/50, more preferably from 10/90 to 40/60, still more preferably from 15/85 to 30/70.

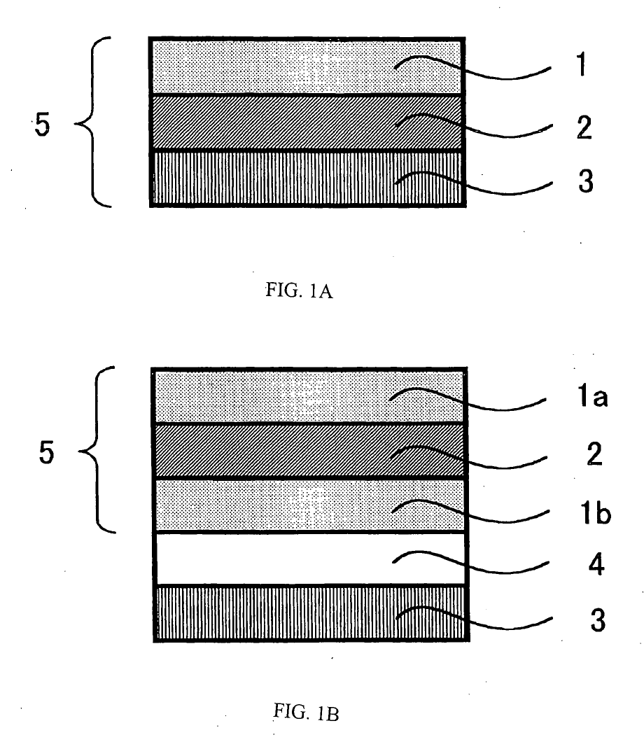

The polarizing plate in one embodiment of the present invention comprises a functional optical film described above. FIGS. 1A and 1B are cross-sectional views for explaining one example of the construction where the polarizing plate of the present invention is combined with the functional optical film. In FIG. 1A, the polarizing plate 5 of the present invention is constructed by laminating the cellulose acylate film of the present invention as a protective film 1 to one surface of a polarizer 2 and laminating the above-described functional optical film 3 to another surface. In FIG. 1B, the polarizing plate 5 of the present invention constructed by laminating the cellulose acylate film of the present invention as protective films 1a and 1b to both surfaces of a polarizer 2 and laminating the above-described functional optical film 3 to the protective film 1b surface on the opposite side to the polarizer 2 through an adhesive layer 4.

### [Liquid Crystal Display Device Using Polarizing Plate]

The cellulose acylate film of the present invention, the optically-compensatory sheet comprising the cellulose acylate film, and the polarizing plate using the cellulose acylate film can be used for liquid crystal cells and liquid crystal display devices in various display modes.

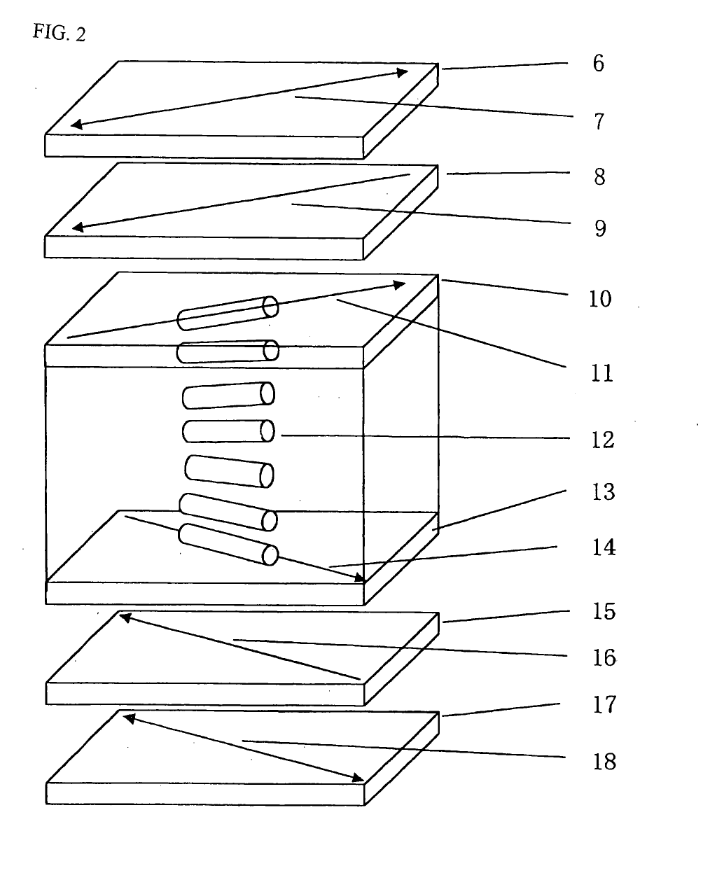

FIG. 2 is a view for explaining one example of a liquid crystal display device using the polarizing plate of the present invention. In FIG. 2, the liquid crystal display device has a structure having a liquid crystal cell containing liquid crystal molecules 12, between an upper polarizing plate 6 and a lower polarizing plate 17. A liquid crystal upper electrode substrate 10 and a liquid crystal cell lower electrode substrate 13 are provided on the liquid crystal cell. Also, an upper optically anisotropic layer 8 is provided between the upper polarizing plate 6 and the liquid crystal cell, and a lower optically anisotropic layer 15 is provided between the lower polarizing plate 17 and the liquid crystal cell. The absorption axis 7 of the upper polarizing plate, the orientation control direction 11 of the upper substrate, and the orientation control direction 9 of the upper optical anisotropic layer are parallel to each other, and with respect to these directions, the absorption axis 18 of the lower polarizing plate, the orientation control direction 14 of the lower substrate, and the orientation control direction 16 of the lower optical anisotropic layer are crossing at right angles.

As for the display mode of the liquid crystal cell, there have been proposed various display modes such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic).

The OCB-mode liquid crystal cell is a liquid crystal display device using a liquid crystal cell of bend alignment mode where rod-like liquid crystalline molecules are aligned substantially in opposite directions (symmetrically) between the upper part and the lower part of the liquid crystal cell. The OCB-mode liquid crystal cell is disclosed in U.S. Pat. Nos. 4,583,825 and 5,410,422. Since rod-like liquid crystalline molecules are aligned symmetrically between the upper part and the lower part of the liquid crystal cell, the liquid crystal cell of bend alignment mode has a self-optically compensating ability. A liquid crystal display device of bend alignment mode is advantageous in that the response speed is fast.

In the VA-mode liquid crystal cell, rod-like liquid crystalline molecules are oriented substantially in the vertical alignment when a voltage is not applied.

The VA-mode liquid crystal cell includes (1) a VA-mode liquid crystal cell in a narrow sense where rod-like liquid crystalline molecules are oriented substantially in a vertical alignment at the time of not applying a voltage and oriented substantially in a horizontal alignment at the time of applying a voltage (described in JP-A-2-176625); (2) a (MVA-mode) liquid crystal cell where the VA mode is modified to a multi-domain system for enlarging the viewing angle (described in SID97, Digest of Tech. Papers (preprints), 28, 845 (1997)); (3) a (n-ASM-mode) liquid crystal cell where rod-like liquid crystalline molecules are oriented substantially in a vertical alignment at the time of not applying a voltage and oriented in a twisted multi-domain alignment at the time of applying a voltage (described in Sharp Giho (Technical Report by Sharp), No. 80, page 11); and (4) a SURVAIVAL-mode liquid crystal cell (reported in Gekkan Display (Monthly Display), May issue, page 14 (1999)).

FIG. 3 is a cross-sectional view for explaining one example of a VA-mode liquid crystal display device using the polarizing plate of the present invention. The VA-mode liquid crystal display device comprises a VA-mode liquid crystal cell 31 and two polarizing plates 30 and 32 disposed on both side of the liquid crystal cell. The VA-mode liquid crystal cell 31 carries a liquid crystal between two electrode substrates. The polarizing plate 30 disposed on the viewer side is in the form of a polarizer 34 being sandwiched by cellulose acylate films 33. The polarizing plate 32 disposed on the backlight side is in the form of a polarizer 34 being sandwiched by cellulose acylate film 33. Out of two cellulose acylate films on the liquid crystal cell side, at least one sheet is the cellulose acylate film of the present invention.

In another embodiment of the liquid crystal display device of the present invention, an optically-compensatory sheet comprising the cellulose acylate film of the present invention is used as the transparent protective film of the polarizing plate, which is disposed between the liquid crystal cell and the polarizer. The optically-compensatory sheet may be used only as the transparent protective film (between the liquid crystal cell and the polarizer) of one polarizing plate, or the optically-compensatory sheet may be used as two transparent protective films (between the liquid crystal cell and the polarizer) of both polarizing plates. In the case of using the optically-compensatory sheet only for one polarizing plate, the optically-compensatory sheet is preferably used as the liquid crystal cell-side protective film of the backlight-side polarizing plate of the liquid crystal cell. The lamination to the liquid crystal cell is preferably performed by arranging the cellulose acylate film of the present invention on the VA cell side. The protective film on the opposite side to the liquid cell side may be a normal cellulose acylate film and preferably has a thickness smaller than the cellulose acylate film of the present invention. For example, a film having a thickness is of 40 to 80 μm is preferred. Examples of the commercial product for such a film include, but are not limited to, KC4UX2M (produced by Konica Opto Corp., 40 μm), KC5UX (produced by Konica Opto Corp., 60 μm), and TD80 (produced by Fuji Photo Film Co., Ltd., 80 μm).

### EXAMPLES

The present invention is described in greater detail by referring to Examples, but the present invention is not limited to these specific examples.

### [Production of Cellulose Acylate Film]

### Example 1-1

### Production of Cellulose Acylate Film (CAF1)

### [Preparation of Cellulose Acylate Stock Solution (CAL-1)]

Cellulose Acylate Stock Solution (CAL-1) is prepared by charging the following composition into a mixing tank and stirring it to dissolve respective components.

{Composition of Cellulose Acylate Stock Solution (CAL-1)}

| | |
|---|---|
| Cellulose acetate having an acetylation | 100.0 parts by mass |
| degree of 2.79 | |
| Triphenyl phosphate (plasticizer, | 7.0 parts by mass |
| hereinafter “TPP”) | |
| Biphenyl phosphate (plasticizer, hereinafter | 3.5 parts by mass |
| “BDP”) | |
| Methylene chloride (first solvent) | 402.0 parts by mass |
| Methanol (second solvent) | 60.0 parts by mass |

### [Preparation of Matting Agent Solution (Ma-1)]

Matting Agent Solution (Ma-1) is prepared by charging the following composition into a disperser and stirring it to dissolve respective components.

{Composition of Matting Agent Solution (Ma-1)}

| | |
|---|---|
| Silica particle having an average particle | 2.0 parts by mass |
| diameter or 20 nm, “AEROSIL R972” | |
| produced by Nihon Aerosil Co., Ltd. | |
| Methylene chloride (first solvent) | 75.0 parts by mass |
| Methanol (second solvent) | 12.7 parts by mass |
| Cellulose Acylate Stock Solution (CAL-1) | 10.3 parts by mass |

### [Preparation of Retardation Developer Solution (Re-1)]

A retardation developer solution is prepared by charging the following composition into a mixing tank and stirring it under heating to dissolve respective components.

{Composition of Retardation Developer Solution}

| | |
|---|---|
| Retardation Developer (A) | 20.0 parts by mass |
| Methylene chloride (first solvent) | 58.4 parts by mass |
| Methanol (second solvent) | 8.7 parts by mass |
| Cellulose Acylate Stock Solution (CAL-1) | 12.8 parts by mass |

Retardation Developer A:

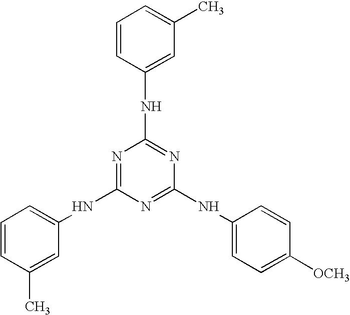

### [Production of Cellulose Acylate Film (CAF1)]

94.5 Parts by mass of Cellulose Acylate Stock Solution (CAL-1), 1.3 parts by mass of Matting Agent Solution (Ma-1) and 4.2 parts by mass of Retardation Developer Solution (Re-1) are mixed after filtering each solution, and the mixture is cast using a band casting machine. The film obtained with a residual solvent content of 30 mass % is separated from the band and dried at an ambient temperature of 140° C. The obtained film is transversely 25% stretched using a tenter at a stretching temperature of 150° C. and a stretching rate of 120%/min to produce (CAF1). Details of the composition and stretching conditions of the cellulose acylate film are shown in Tables 1 and 2.

### Example 1-2

### Production of Cellulose Acylate Film (CAF2)

Cellulose Acylate Film (CAF2) is produced in the same manner except that in the production of Cellulose Acylate Film (CAF1), the amount added of Retardation Developer (A) and the stretching conditions are changed as shown in Tables 1 and 2.

### Example 1-3

### Production of Cellulose Acylate Film (CAF3)

### [Preparation of Cellulose Acylate Stock Solution (CAL-3)]

Cellulose Acylate Stock Solution (CAL-3) is prepared by charging the following composition into a mixing tank and stirring it to dissolve respective components.

{Composition of Cellulose Acylate Stock Solution (CAL-3)}

| | |
|---|---|
| Cellulose acetate having an acetylation | 100.0 parts by mass |
| degree of 1.80 and a propionylation degree | |
| of 0.90 | |
| Triphenyl phosphate | 8.0 parts by mass |
| Ethylphthalyl ethyl glycolate (plasticizer, | 2.0 parts by mass |
| hereinafter “EPEG”) | |
| Methylene chloride (first solvent) | 362.0 parts by mass |
| Ethanol (second solvent) | 100.0 parts by mass |

### [Preparation of Matting Agent Solution (Ma-3)]

Matting Agent Solution (Ma-3) is prepared by charging the following composition into a disperser and stirring it to dissolve respective components.

{Composition of Matting Agent Solution (Ma-3)}

| | |
|---|---|
| Silica particle having an average particle | 2.0 parts by mass |
| diameter of 20 nm, “AEROSIL R972” | |
| produced by Nihon Aerosil Co., Ltd. | |
| Methylene chloride (first solvent) | 75.0 parts by mass |
| Ethanol (second solvent) | 12.7 parts by mass |
| Cellulose Acylate Stock Solution (CAL-3) | 10.3 parts by mass |

### [Production of Cellulose Acylate Film (CAF3)]

98.7 Parts by mass of Cellulose Acylate Stock Solution (CAL-3) and 1.3 parts by mass of Matting Agent Solution (Ma-3) are mixed after filtering each solution, and the mixture is cast using a band casting machine. The film obtained with a residual solvent content of 20 mass % is separated from the band and dried at an ambient temperature of 140° C. The obtained film is transversely 35% stretched using a tenter at a stretching temperature of 145° C. and a stretching rate of 150%/min to produce (CAF3).

### Examples 1-4 to 1-1

### Production of Cellulose Acylate Films (CAF4) to (CAF11)

Cellulose Acylate Films (CAF4) to (CAF11) are produced in the same manner except that in the production of Cellulose Acylate Film (CAF3), the kind and amount added of the additive and the stretching conditions are changed as shown in Tables 1 and 2. Incidentally, in CAF11, the acyl substitution conditions are changed.

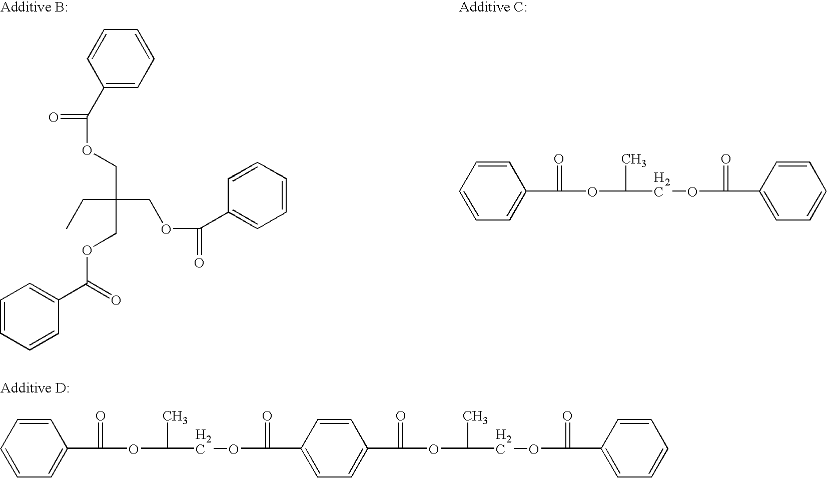

### Comparitive Examples 1-1 to 1-7

### Production of Cellulose Acylate Films (CAF12) to (CAF-18)

Cellulose Acylate Films (CAF12) to (CAF18) of Comparative Examples are produced in the same manner except that in the production of Cellulose Acylate Films (CAF1 to CAF3), the kind and amount added of the additive and the stretching conditions are changed as shown in Tables 1 and 2.

TABLE 1

| | Cellulose Acylate Film (composition) | | | | | | | | | |
|---|---|---|---|---|---|---|---|---|---|---|
| | | Cellulose Acylate | | | Additive 1 | | Additive 2 | | Additive 3 | |
| | | Total Acyl | | | | Amount | | Amount | | Amount |
| | | Substitution | Acetylation | Propionylation | | Added*¹ | | Added*¹ | | Added*¹ |
| | No. | Degree | Degree | Degree | Kind | (mass %) | Kind | (mass %) | Kind | (mass %) |
| Example 1-1 | CAF 1 | 2.79 | 2.79 | — | TPP | 7 | BDP | 3.5 | A | 6.3 |
| Example 1-2 | CAF 2 | 2.79 | 2.79 | — | TPP | 7 | BDP | 3.5 | A | 7.5 |
| Example 1-3 | CAF 3 | 2.70 | 1.80 | 0.90 | TPP | 8 | EPEG | 2 | — | — |
| Example 1-4 | CAF 4 | 2.70 | 1.80 | 0.90 | TPP | 8 | A | 3 | — | — |
| Example 1-5 | CAF 5 | 2.70 | 1.80 | 0.90 | TPP | 8 | — | — | — | — |
| Example 1-6 | CAF 6 | 2.70 | 1.80 | 0.90 | TPP | 8 | EPEG | 2 | — | — |
| Example 1-7 | CAF 7 | 2.70 | 1.80 | 0.90 | TPP | 8 | EPEG | 2 | — | — |
| Example 1-8 | CAF 8 | 2.70 | 1.80 | 0.90 | TPP | 8 | EPEG | 2 | — | — |
| Example 1-9 | CAF 9 | 2.70 | 1.80 | 0.90 | TPP | 8 | EPEG | 2 | — | — |
| Example 1-10 | CAF 10 | 2.70 | 1.80 | 0.90 | TPP | 8 | EPEG | 2 | — | — |
| Example 1-11 | CAF 11 | 2.35 | 1.55 | 0.80 | B | 5 | C | 3 | D | 2 |
| Comparative | CAF 12 | 2.7 | 1.80 | 0.90 | TPP | 8 | EPEG | 2 | — | — |
| Example 1-1 | | | | | | | | | | |
| Comparative | CAF 13 | 2.7 | 1.80 | 0.90 | TPP | 8 | EPEG | 2 | — | — |
| Example 1-2 | | | | | | | | | | |
| Comparative | CAF 14 | 2.7 | 1.80 | 0.90 | TPP | 8 | EPEG | 2 | — | — |
| Example 1-3 | | | | | | | | | | |
| Comparative | CAF 15 | 2.7 | 1.80 | 0.90 | TPP | 8 | EPEG | 2 | — | — |
| Example 1-4 | | | | | | | | | | |
| Comparative | CAF 16 | 2.79 | 2.79 | — | TPP | 7 | BDP | 3.5 | A | 6.3 |
| Example 1-5 | | | | | | | | | | |
| Comparative | CAF 17 | 2.7 | 1.80 | 0.90 | TPP | 8 | EPEG | 2 | — | — |
| Example 1-6 | | | | | | | | | | |
| Comparative | CAF 18 | 2.70 | 1.80 | 0.90 | TPP | 8 | BDP | 2 | — | — |
| Example 1-7 | | | | | | | | | | |

Amount Added*¹: Mass % based on the mass of film.

TABLE 2

| | | | (Stretching | |
|---|---|---|---|---|
| | | | Temperature − | |
| | | Stretching | Glass Transition | Solvent |
| | Stretch Ratio | Rate | Temperature) | Content |
| | (%) | (%/min) | (° C.) | (mass %) |
| Example 1-1 | 25 | 120 | 20 | 0.2 |
| Example 1-2 | 30 | 135 | 25 | 0.2 |
| Example 1-3 | 35 | 150 | 10 | 0.1 |
| Example 1-4 | 35 | 150 | 10 | 0.1 |
| Example 1-5 | 35 | 150 | 10 | 0.1 |
| Example 1-6 | 35 | 85 | 10 | 0.1 |
| Example 1-7 | 35 | 185 | 10 | 0.1 |
| Example 1-8 | 35 | 150 | 10 | 3.8 |
| Example 1-9 | 35 | 150 | 3 | 0.1 |
| Example 1-10 | 35 | 150 | 29 | 0.1 |
| Example 1-11 | 30 | 160 | 15 | 0.2 |
| Comparative | 35 | 50 | 10 | 0.1 |
| Example 1-1 | | | | |
| Comparative | 35 | 240 | 10 | 0.1 |
| Example 1-2 | | | | |
| Comparative | 35 | 150 | −1 | 0.1 |
| Example 1-3 | | | | |
| Comparative | 35 | 150 | 40 | 0.1 |
| Example 1-4 | | | | |
| Comparative | 25 | 120 | 20 | 19 |
| Example 1-5 | | | | |
| Comparative | 35 | 150 | 10 | 62 |
| Example 1-6 | | | | |
| Comparative | 35 | 150 | 10 | 0.1 |
| Example 1-7 | | | | |

The cellulose acylate film is dried at 120° C. for 2 hours before the stretch, and the solvent content is obtained from mass change through the drying by the following formula:

Solvent Content=(Mass before drying−Mass after drying)/Mass after drying×100

### [Measurement of Film Characteristic Values]

### [Measurement of Retardation]

With respect to the cellulose acylate films produced above, Re and Rth at a wavelength of 590 nm are measured at 25° C. and 60% RH by an automatic birefringence meter “KOBRA-21ADH” {manufactured by Oji Test Instruments}.

### [Measurement of Haze]

A film sample of 40 mm×80 mm is measured according to JIS K-7136 by a haze meter (HGM-2DP, manufactured by Suga Test Instruments Co., Ltd.) at 25° C. and 60% RH.

### [X-Ray Measurement]

An X ray at 50 kV-300 mA is generated by “ATX-G” manufactured by Rigaku Corp. using a Cu tube as the X-ray source. As for the in-plane orientation degree (orientation order parameter) Pₒ on the film surface, the in-plane orientation degree (orientation order parameter) Pₒ of the cellulose acylate molecular chain in the film surface is determined according to formula (11) from the peak intensity of 2θ_{χ}/Φ=6 to 11° detected using a thin-film X-ray in-plane measurement by rotating the X-ray detector and the sample at angles of 2θ_{χ} and Φ.

An X ray at 50 kV-100 mA is generated by “RAPID R-AXIS” manufactured by Rigaku Corp. using a Cu tube as the X-ray source. The collimator is for 0.8 mmΦ and the film sample is fixed using a transmission sample table. The exposure time is set to 180 seconds. In this way, the average orientation degree Pₜ in the entire film thickness is measured, and Pₒ/Pₜ is determined.

Also, a cross-sectional plane parallel to the xz plane of the film is divided into five equal parts over the region from support side to air interface side which are positions at the film formation, the orientation degree in the film cross-sectional plane at each portion is measured using an X-ray beam at several μm to tens of μm, and the average value of out-plane orientation degrees in the thickness direction and the fluctuation coefficient of the out-plane orientation degree are measured.

### [Measurement of Concentration Distribution of Additive in Film Thickness Direction]

A cross-sectional plane parallel to the xz plane of the film before stretching is divided into five equal parts over the region from support side to air interface side which are positions at the film formation, and each portion is measured by a time-of-flight secondary ion mass spectrometer (TOF-SIMS). The concentration distribution of the additive is determined by taking an intensity ratio between the positive ion peak M/Z=109 (C₆H₅O₂⁺) assigned to the decomposition product of cellulose acylate and the peak of molecule+H⁺ ion of the additive. The measurement portions are designated as B1, B2, CT, A2 and A1 from the side closer to the support side which is a position at the film formation. These measurement portions are at equal intervals in the film thickness direction. The fluctuation coefficient of concentration in the thickness direction, represented by formula (12) is also determined.

The results are shown in Tables 3 and 4.

TABLE 3

| | | | | | | In-Plane | | | | |
|---|---|---|---|---|---|---|---|---|---|---|
| | Film | Retardation Value | | | | Orientation Degree | | | Out-Plane Orientation Degree | |
| | Thickness | Re | Rth | | | In Plane | | | Average | Fluctuation Coefficient |
| | (μm) | (nm) | (nm) | Rth/Re | Haze | Pₒ | Pₜ | Pₒ/Pₜ | Value | (%) |
| Example 1-1 | 76 | 56 | 195 | 3.5 | 0.75 | 0.029 | 0.031 | 0.94 | 0.09 | 4.1 |
| Example 1-2 | 61 | 45 | 138 | 3.1 | 0.52 | 0.034 | 0.036 | 0.94 | 0.11 | 3.5 |
| Example 1-3 | 81 | 62 | 145 | 2.3 | 0.51 | 0.049 | 0.051 | 0.96 | 0.12 | 2.1 |
| Example 1-4 | 80 | 46 | 124 | 2.7 | 0.44 | 0.048 | 0.050 | 0.96 | 0.12 | 1.7 |
| Example 1-5 | 83 | 42 | 117 | 2.8 | 0.74 | 0.047 | 0.052 | 0.90 | 0.12 | 4.2 |
| Example 1-6 | 78 | 42 | 118 | 2.8 | 0.65 | 0.045 | 0.049 | 0.92 | 0.11 | 3.2 |
| Example 1-7 | 79 | 46 | 121 | 2.6 | 0.48 | 0.046 | 0.049 | 0.94 | 0.11 | 2.1 |
| Example 1-8 | 82 | 42 | 110 | 2.6 | 0.78 | 0.043 | 0.048 | 0.90 | 0.11 | 4.6 |
| Example 1-9 | 81 | 48 | 132 | 2.8 | 0.77 | 0.049 | 0.053 | 0.92 | 0.13 | 3.0 |
| Example 1-10 | 80 | 37 | 107 | 2.9 | 0.68 | 0.038 | 0.041 | 0.93 | 0.10 | 2.1 |
| Example 1-11 | 43 | 40 | 117 | 2.9 | 0.55 | 0.043 | 0.047 | 0.91 | 0.12 | 2.9 |
| Comparative Example 1-1 | 80 | 39 | 110 | 2.8 | 0.84 | 0.042 | 0.049 | 0.86 | 0.10 | 5.9 |
| Comparative Example 1-2 | ruptured at stretching | | | | | | | | | |
| Comparative Example 1-3 | ruptured at stretching | | | | | | | | | |
| Comparative Example 1-4 | 78 | 19 | 60 | 3.2 | 0.67 | 0.019 | 0.021 | 0.90 | 0.06 | 2.2 |
| Comparative Example 1-5 | 77 | 39 | 152 | 3.9 | 0.91 | 0.024 | 0.022 | 1.09 | 0.07 | 5.6 |
| Comparative Example 1-6 | 81 | 28 | 95 | 3.4 | 1.10 | 0.065 | 0.034 | 1.91 | 0.09 | 7.8 |
| Comparative Example 1-7 | 80 | 30 | 101 | 3.4 | 0.83 | 0.028 | 0.033 | 0.85 | 0.10 | 5.2 |

TABLE 4

| | Concentration Distribution* of Additive | | | | | | | | |
|---|---|---|---|---|---|---|---|---|---|
| | Additive 1 | | | Additive 2 | | | Additive 3 | | |
| | Maximum | Minimum | | Maximum | | | Maximum | Minimum | |
| | Concen- | Concen- | Fluctuation | Concen- | Minimum | Fluctuation | Concen- | Concen- | Fluctuation |
| | tration | tration | Coefficient | tration | Concentration | Coefficient | tration | tration | Coefficient |
| | Position | Position | (%) | Position | Position | (%) | Position | Position | (%) |
| Example 1-1 | B1 | A2 | 41 | B1 | A2 | 45 | A1 | A2 | 48 |
| Example 1-2 | B1 | A2 | 36 | B1 | A2 | 38 | A1 | A2 | 35 |
| Example 1-3 | B1 | A2 | 33 | A2 | A1 | 12 | — | — | — |
| Example 1-4 | B1 | A2 | 33 | A1 | A2 | 12 | — | — | — |
| Example 1-5 | B1 | A2 | 33 | A2 | A1 | 12 | — | — | — |
| Example 1-6 | B1 | A2 | 33 | A2 | A1 | 12 | — | — | — |
| Example 1-7 | B1 | A2 | 33 | A2 | A1 | 12 | — | — | — |
| Example 1-8 | B1 | A2 | 33 | A2 | A1 | 12 | — | — | — |
| Example 1-9 | B1 | A2 | 33 | A2 | A1 | 12 | — | — | — |
| Example 1-10 | B1 | A2 | 33 | A2 | A1 | 12 | — | — | — |
| Example 1-11 | B1 | A2 | 21 | A2 | A1 | 19 | B1 | A2 | A2 |
| Comparative | B1 | A2 | 33 | A2 | A1 | 19 | — | — | — |
| Example 1-1 | | | | | | | | | |
| Comparative | B1 | A2 | 33 | A2 | A1 | 19 | — | — | — |
| Example 1-2 | | | | | | | | | |
| Comparative | B1 | A2 | 33 | A2 | A1 | 19 | — | — | — |
| Example 1-3 | | | | | | | | | |
| Comparative | B1 | A2 | 33 | A2 | A1 | 19 | — | — | — |
| Example 1-4 | | | | | | | | | |
| Comparative | B1 | A2 | 32 | B1 | A2 | 34 | A1 | A2 | 35 |
| Example 1-5 | | | | | | | | | |
| Comparative | B1 | A2 | 21 | A2 | A1 | 8 | — | — | — |
| Example 1-6 | | | | | | | | | |
| Comparative | B1 | A2 | 35 | B1 | A2 | 8 | — | — | — |
| Example 1-7 | | | | | | | | | |

*Denoted as B1, B2, CT, A2 and A1 from the side closer to the support surface which is a position at the film formation.

It is seen from the results in Table 3 that the cellulose acylate film of the present invention has high uniformity of the orientation degree of the cellulose acylate molecular chain in the film thickness direction as compared with comparative samples and high retardation developability and low haze are thereby obtained.

### [Production of Polarizing Plate]

### Examples 2-1 to 2-11 and Comparative Examples 2-1 to 2-7

### [Saponification Treatment of Cellulose Acylate Film]

The cellulose acylate films produced in Examples 1-1 to 1-11 and Comparative Examples 1-1 to 1-7 each is dipped in an aqueous 1.4 mol/L sodium hydroxide solution at 55° C. for 2 minutes, then washed in a water-washing bath at room temperature and neutralized using 0.05 mol/L of sulfuric acid at 30° C. The film is again washed in a water-washing bath at room temperature and then dried with hot air at 110° C. In this way, the surface of each cellulose acylate film is saponified.

Also, a commercially available cellulose triacetate film, “FUJI-TAC TD80UF” {produced by Fuji Photo Film Co., Ltd.}, is saponified under the same conditions and used for the following production of a polarizing plate sample.

### [Production of Polarizer]

A polarizer is produced by adsorbing iodine to a stretch PVA film, and Cellulose Acylate Film (CAF1) produced in Example 1-1 is laminated to one side of the polarizer by using a PVA-based adhesive. The transmission axis of the polarizer and the slow axis of the cellulose acylate film are disposed to run in parallel.

Furthermore, “FUJI-TACK TD80UF” saponified above is laminated to the opposite side of the polarizer by using a PVA-based adhesive. In this way, Polarizing Plate (P1-1) is produced.

Using other cellulose acylate films, Polarizing Plates (P1-2) to (P1-11) and (PR1-1) to (PR1-7) are produced in the same manner (however, the cellulose acylate film of Comparative Examples 1-2 and 1-3 are ruptured at the stretching and therefore, the production of a polarizing plate is not performed).

### Example 3-1 and Comparative Example 3-1

### [Production and Evaluation 1 of VA-Mode Liquid Crystal Display Device]

A liquid crystal display device shown in FIG. 3 is produced.

More specifically, an upper polarizing plate, a VA-mode liquid crystal cell (comprising an upper substrate, a liquid crystal layer and a lower substrate), and a lower polarizing plate are stacked from the viewing direction (top), and a backlight source is further disposed.

In the following Examples, a commercially available polarizing plate, “HLC2-5618” {produced by Sanritz Corp.}, is used for the upper polarizing plate, and the polarizing plate of the present invention is used for the lower polarizing plate.

### [Production of Liquid Crystal Cell]

A liquid crystal cell is produced by setting the cell gap between substrates to 3.6 μm, injecting dropwise a liquid crystal material with negative dielectric anisotropy (“MLC6608”, produced by Merck Ltd.) between the substrates, and encapsulating it to form a liquid crystal layer between the substrates. The retardation of the liquid crystal layer (that is, a product Δn·d of the thickness d (μm) and the refractive index anisotropy Δn of the liquid crystal layer) is set to 300 nm. Incidentally, the liquid crystal material is oriented in the vertical alignment.

The commercially available superhigh contrast product, “HLC2-5618”, is used for the upper polarizing plate of a liquid crystal display device (FIG. 3) using the vertically aligned liquid crystal cell produced above, and Polarizing Plate (P11) produced in Example 2-1 is used for the lower polarizing plate and disposed such that Cellulose Acylate Film (CAF1) of the present invention serving as one protective film of the polarizer comes to the liquid crystal cell side. Each polarizing plate is laminated to the liquid crystal cell through a pressure-sensitive adhesive. At this time, a cross-Nicol arrangement is employed by arranging the transmission axis of the polarizing plate on the viewer side to run in the vertical direction and arranging the transmission axis of the polarizing plate on the backlight side to run in the horizontal direction.

Polarizing Plate (PR1-1) produced in Comparative Example 1 using Cellulose Acylate Film (CAF12) obtained in Comparative Example 1 is also used for the production of a liquid crystal display device by disposing it as the lower polarizing plate.

The liquid crystal display device using Polarizing Plate (P1-1) of the present invention advantageously exhibits high contrast in both observations from the front and from the oblique direction as compared with the liquid crystal display using Polarizing Plate (PR1-1) of Comparative Example.

### Example 4-1

### [Production and Evaluation 2 of VA-Mode Liquid Crystal Display Device]

### [Production of Liquid Crystal Cell]

1 Parts by mass of octadecyldimethylammonium chloride (coupling agent) is added to 100 parts by mass of an aqueous 3 mass % PVA solution, and the resulting solution is spin-coated on a glass substrate with an ITO electrode, heat-treated at 160° C. and then subjected to a rubbing treatment to form a orientation film for vertical alignment. The rubbing treatment is performed in opposite directions between two glass substrates. The two glass plates are placed to face each other and create a cell gap (d) of 5 μm. A liquid crystalline compound (Δn: 0.08) mainly comprising ester-based and ethane-based liquid crystals is injected into the cell gap to produce a vertically aligned liquid crystal cell. The product of Δn and d (that is, the retardation of the liquid crystal layer) is 400 nm.

The polarizing plate (P1-3, a polarizing plate using Cellulose Acylate Film (CAF3) of the present invention) produced in Example 2-3 is previously moisture-conditioned under the temperature and humidity conditions of 25° C. and 60% RH, then packaged in a bag subjected to a moisture-proofing treatment, and left standing for 3 days. The bag is a packaging material comprising a laminate structure of polyethylene terephthalate/aluminum/polyethylene, and the moisture permeability thereof is 1×10⁻⁵ g/m²·day or less.

Polarizing Plate (P1-3) is taken out in an environment of 25° C. and 60% RH and laminated on both surfaces of the vertically aligned liquid crystal cell produced above, by using a pressure-sensitive adhesive sheet such that Cellulose Acylate Film (CAF3) of the present invention comes to the liquid crystal cell side. In this way, a liquid crystal display device is produced.

Liquid crystal display devices are produced in the same manner by using Polarizing Plates (P1-2) and (P1-4) to (P1-11) of the present invention and Polarizing Plate (PR1-7) of Comparative Example.

The liquid crystal display device using the polarizing plate of the present invention is found to advantageously exhibit high contrast in both observations from the front and from the oblique direction as compared with the liquid crystal display device using the polarizing plate of Comparative Example.

According to the present invention, a polymer film assured of large retardation and low haze and useful as a protective film or an optically-compensatory film, and a production method thereof are provided.

Also, according to the present invention, a polarizing plate using the polymer film and ensuring that a high-contrast high-quality image can be displayed, and a liquid crystal display device using the polarizing plate are provided.

The entire disclosure of each and every foreign patent application from which the benefit of foreign priority has been claimed in the present application is incorporated herein by reference, as if fully set forth.

What is claimed is:

1. A polymer film satisfying the following formulae (1) and (2):
0.025≦Pₜ≦0.100 Formula (1)
0.90≦Pₒ/Pₜ≦0.99 Formula (2)
wherein Pₒ represents an in-plane orientation degree of polymer molecular chain in the film surface, and
Pₜ represents an average in-plane orientation degree of polymer molecular chain in the entire film thickness.

2. A polymer film according to claim 1, satisfying the following formulae (3) and (4):
0.070≦Qₘ≦0.150 Formula (3)
0.01%≦Q_{f}≦5% Formula (4)
wherein Qₘ represents an average value of Q in a thickness direction, in which Q represents an out-plane orientation degree of polymer molecular chain, and
Q_{f} represents a fluctuation coefficient of out-plane orientation degree, represented by the following formula (A):
Q_{f}=100×(maximum value of Q−minimum value of Q)/Qₘ. Formula (A)

3. The polymer film according to claim 1, satisfying the following formulae (5) to (7):
20 nm≦Re(590)≦200 nm Formula (5)
70 nm≦Rth(590)≦400 nm Formula (6)
1≦Rth(590)/Re(590)≦10 Formula (7)
wherein Re(590) represents an in-plane retardation at a wavelength of 590 nm, and
Rth(590) represents a retardation in a thickness direction at a wavelength of 590 nm.

4. The polymer film according to claim 1, having a haze of from 0.01 to 0.8%.

5. The polymer film according to claim 1, having a thickness of from 20 to 100 μm.

6. A production method of a polymer film, comprising:
a step of stretching a polymer film which contains a solvent of from 0.01 to 4 mass % at a stretching temperature of from glass transition temperature of the film to glass transition temperature of the polymer film+30° C. and at a stretching rate of from 80%/min to 190%/min.

7. The production method according to claim 6,
wherein the polymer film satisfies the following conditions (i) and at least one of (ii) and (iii):
(i) the polymer film contains at least two kinds of additives,
(ii) in a concentration distribution in a thickness direction of each of the at least two kinds of additives, a position in the thickness direction exhibiting the minimum concentration differs from each other,
(iii) in the concentration distribution in a thickness direction of each of the at least two kinds of additives, a position in the thickness direction exhibiting the maximum concentration differs from each other.

8. The production method according to claim 7,
wherein each of the at least two kinds of additives is selected from the group consisting of a plasticizer, a retardation developer, a retardation decreasing agent and an ultraviolet absorbent.

9. The polymer film according to claim 1, which is produced by the production method comprising:
a step of stretching a polymer film which contains a solvent of from 0.01 to 4 mass % at a stretching temperature of from glass transition temperature of the film to glass transition temperature of the polymer film+30° C. and at a stretching rate of from 80%/min to 190%/min.

10. The polymer film according to claim 9, comprising a cellulose acylate.

11. A polarizing plate comprising:
a polarizer; and
a pair of protective films between which the polarizer is sandwiched,
wherein at least one of the protective films is the polymer film according to claim 1.

12. A liquid crystal display device comprising:
a liquid cell; and
two polarizing plates disposed on both sides of the liquid cell,
wherein at least one of the polarizing plates is the polarizing plate according to claim 11.
